(19) United States
(12) Patent Application Publication
(10) Pub. No.: US 2022/0388291 A1
(43) Pub. Date: Dec. 8, 2022

(54) MULTILAYER COMPOSITE WITH THERMAL BARRIER PROPERTIES

(71) Applicant: SAINT-GOBAIN PERFORMANCE PLASTICS CORPORATION, Solon, OH (US)

(72) Inventors: Fei Wang, Winchester, MA (US); Chuanping Li, Shrewsbury, MA (US); Rachel Brown, Shrewsbury, MA (US); Roger P. Zaleski, North Grafton, MA (US); Charles Leyder, Paris (FR); Jan Faltin, Mönchengladbach (DE); Senthil Jayaseelan, Mechanicville, NY (US); Steven R. Jette, Auburn, MA (US); Arthur L. Adam, JR., North Grosvenordale, CT (US); Nicholas David Orf, Natick, MA (US)

(21) Appl. No.: 17/804,134

(22) Filed: May 26, 2022

Related U.S. Application Data
(60) Provisional application No. 63/196,077, filed on Jun. 2, 2021.

(51) Int. Cl. B32B 27/28; C08L 83/06; C08K 3/016; C08K 3/38; C08K 3/36; C08K 3/26; C08K 3/11; C08K 3/22

(52) U.S. Cl. CPC B32B 27/28; C08L 83/06; C08K 3/016; C08K 3/38; C08K 3/36; C08K 3/26; C08K 3/11; C08K 3/22; C08K 2003/387; C08K 2003/267

(57) ABSTRACT

The present disclosure relates to a multilayer composite that may include a multilayer composite that may include a first barrier layer and a first foam layer. The first foam layer may include a silicone-based matrix component, a flame retardant filler component, and an insulation filler component. The multilayer component may have a thickness of at least about 0.5 mm and no greater than about 10 mm. The multilayer component may also have a HBF flammability rating as measured according to ASTM D4986.

### CROSS-REFERENCE TO RELATED APPLICATION(S)

This application claims priority under 35 U.S.C. § 119(e) to U.S. Provisional Patent Application No. 63/196,077, entitled “MULTILAYER COMPOSITE WITH THERMAL BARRIER PROPERTIES,” by Fei Wang et al., filed Jun. 2, 2021, which is assigned to the current assignee hereof and incorporated herein by reference in its entirety.

### FIELD OF THE DISCLOSURE

The present disclosure relates to a multilayer composite and, in particular, a multilayer composite for use as a thermal barrier in various applications, for example, in a battery pack, and methods of forming the same.

### BACKGROUND

Multilayer composite films may be designed for high-temperature protection in various applications, for example, for use as thermal barriers in electric vehicle battery packs, thermal barrier coverings in high-temperature cable protection, thermal barrier containers for thermal spray containment, etc. However, in these, and in other applications, potential heat growth continues to increase due to improvements in technology. Accordingly, there is a continuing need for improved barrier designs that protect against such high heat potential.

### SUMMARY

According to a first aspect, a multilayer composite may include a first barrier layer and a first foam layer. The first foam layer may include a silicone-based matrix component, a flame retardant filler component, and an insulation filler component. The multilayer component may have a thickness of at least about 0.5 mm and no greater than about 10 mm. The multilayer component may also have a HBF flammability rating as measured according to ASTM D4986.

According to another aspect, a multilayer composite may include a first barrier layer and a first foam layer. The first foam layer may include a silicone-based matrix component, a flame retardant filler component, and an insulation filler component. The multilayer component may have a thickness of at least about 0.5 mm and no greater than about 10 mm. The multilayer component may also have a self-ignition time of at least about 1 minute when exposed to a hotplate test at 650° C.

According to still another aspect, a multilayer composite may include a first barrier layer and a first foam layer. The first foam layer may include a silicone-based matrix component, a flame retardant filler component, and an insulation filler component. The first barrier layer may comprise a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof. The flame retardant filler component of the first foam layer may include a filler selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof. The insulation filler component of the first foam layer may include a filler selected from the group consisting of expanded perlite, unexpanded perlite, glass beads, vermiculite, expanded vermiculite, expanded glass, zeolite, aerogel, silica, porous silica, porous alumina, and any combination thereof. The multilayer composite may have a thickness of at least about 0.5 mm and no greater than about 10 mm.

According to another aspect, a thermal barrier composite may include a first barrier layer and a first foam layer. The first foam layer may include a silicone-based matrix component, a flame retardant filler component, and an insulation filler component. The multilayer component may have a thickness of at least about 0.5 mm and no greater than about 10 mm. The multilayer component may also have a HBF flammability rating as measured according to ASTM D4986.

According to another aspect, a thermal barrier composite may include a first barrier layer and a first foam layer. The first foam layer may include a silicone-based matrix component, a flame retardant filler component, and an insulation filler component. The multilayer component may have a thickness of at least about 0.5 mm and no greater than about 10 mm. The multilayer component may also have a self-ignition time of at least about 1 minute when exposed to a hotplate test at 650° C.

According to still another aspect, a thermal barrier composite may include a first barrier layer and a first foam layer. The first foam layer may include a silicone-based matrix component, a flame retardant filler component, and an insulation filler component. The first barrier layer may comprise a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof. The flame retardant filler component of the first foam layer may include a filler selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof. The insulation filler component of the first foam layer may include a filler selected from the group consisting of expanded perlite, unexpanded perlite, glass beads, vermiculite, expanded vermiculite, expanded glass, zeolite, aerogel, silica, porous silica, porous alumina, and any combination thereof. The thermal barrier composite may have a thickness of at least about 0.5 mm and no greater than about 10 mm.

### BRIEF DESCRIPTION OF THE DRAWINGS

Embodiments are illustrated by way of example and are not limited to the accompanying figures.

FIG. 1 includes an illustration of an example multilayer composite according to certain embodiments described herein;

FIG. 2 includes an illustration of an example multilayer composite according to certain embodiments described herein;

FIG. 3 includes an illustration of an example multilayer composite according to certain embodiments described herein;

FIG. 4 includes an illustration of an example thermal barrier composite according to certain embodiments described herein;

FIG. 5 includes an illustration of an example thermal barrier composite according to certain embodiments described herein; and

FIG. 6 includes an illustration of an example thermal barrier composite according to certain embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a multilayer composite that may include a first barrier layer and a first foam layer. According to particular embodiments, the first foam layer may include a silicone-based matrix component, a flame retardant filler component, and an insulation filler component. According to still other embodiments, the multilayer composite may demonstrate a combination of improved performance in flame resistance and compression.

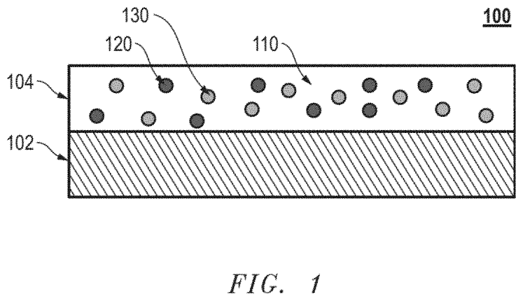

For purposes of illustration, FIG. 1 shows a multilayer composite 100 according to embodiments described herein. As shown in FIG. 1, a multilayer composite 100 may include a first barrier layer 102 and a first foam layer 104. The first foam layer 104 may include a silicone-based matrix component 110, a flame retardant filler component 120, and an insulation filler component 130.

According to particular embodiments, the silicone-based matrix component 110 of the first foam layer 104 may include platinum catalyzed addition cured silicone foam. According to still other embodiments, the silicone-based matrix component 110 may include peroxide cured silicone foam. According to yet other embodiments, the silicone-based matrix component 110 may include tin catalyzed silicone foam. According to still other embodiments, the silicone-based matrix component 110 may include any combination of a platinum catalyzed addition cured silicone foam, a peroxide cured silicone foam, and a tin catalyzed silicone foam.

According to particular embodiments, the silicone-based matrix component 110 may consist of platinum catalyzed addition cured silicone foam. According to still other embodiments, the silicone-based matrix component 110 may consist of peroxide cured silicone foam. According to yet other embodiments, the silicone based matrix component 110 may consist of tin catalyzed silicone foam. According to still other embodiments, the silicone-based matrix component 110 may consist of any combination of a platinum catalyzed addition cured silicone foam, a peroxide cured silicone foam, and a tin catalyzed silicone foam.

According to particular embodiments, the silicone-based matrix component 110 may be a platinum catalyzed addition cured silicone foam layer. According to still other embodiments, the silicone-based matrix component 110 may be a peroxide cured silicone foam layer. According to yet other embodiments, the silicone-based matrix component 110 may be a tin catalyzed silicone foam layer. According to still other embodiments, the silicone-based matrix component 110 may be a layer of any combination of a platinum catalyzed addition cured silicone foam, a peroxide cured silicone foam, and a tin catalyzed silicone foam.

According to yet other embodiments, the flame retardant filler component 120 may be selected from a particular group of materials. For example, the flame retardant filler component 120 may be selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

According to still other embodiments, the flame retardant filler component 120 may include a particular material. For example, the flame retardant filler component 120 may include metal hydrates. According to still other embodiments, the flame retardant filler component 120 may include borate compounds. According to still other embodiments, the flame retardant filler component 120 may include platinum compounds. According to still other embodiments, the flame retardant filler component 120 may include transition metal oxides. According to other embodiments, the flame retardant filler component 120 may include metal carbonates. According to still other embodiments, the flame retardant filler component 120 may include calcium silicates. According to yet other embodiments, the flame retardant filler component 120 may include aluminum silicates. According to yet other embodiments, the flame retardant filler component 120 may include magnesium silicates. According to still other embodiments, the flame retardant filler component 120 may include glass frits. According to still other embodiments, the flame retardant filler component 120 may include alkaline salts. According to yet other embodiments, the flame retardant filler component 120 may include vermiculites. According to still other embodiments, the flame retardant filler component 120 may include any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 120 may consist of a particular material. For example, the flame retardant filler component 120 may consist of metal hydrates. According to still other embodiments, the flame retardant filler component 120 may consist of borate compounds. According to still other embodiments, the flame retardant filler component 120 may consist of platinum compounds. According to still other embodiments, the flame retardant filler component 120 may consist of transition metal oxides. According to other embodiments, the flame retardant filler component 120 may consist of metal carbonates. According to still other embodiments, the flame retardant filler component 120 may consist of calcium silicates. According to yet other embodiments, the flame retardant filler component 120 may consist of aluminum silicates. According to yet other embodiments, the flame retardant filler component 120 may consist of magnesium silicates. According to still other embodiments, the flame retardant filler component 120 may consist of glass frits. According to still other embodiments, the flame retardant filler component 120 may consist of alkaline salts. According to yet other embodiments, the flame retardant filler component 120 may consist of vermiculites. According to still other embodiments, the flame retardant filler component 120 may consist of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 120 may be a particular material. For example, the flame retardant filler component 120 may be a metal hydrate filler. According to still other embodiments, the flame retardant filler component 120 may be a borate salt filler. According to still other embodiments, the flame retardant filler component 120 may be a platinum compound filler. According to still other embodiments, the flame retardant filler component 120 may be a transition metal oxide filler. According to other embodiments, the flame retardant filler component 120 may be a metal carbonate filler. According to still other embodiments, the flame retardant filler component 120 may be a calcium silicate filler. According to yet other embodiments, the flame retardant filler component 120 may be an aluminum silicate filler. According to yet other embodiments, the flame retardant filler component 120 may be a magnesium silicate filler. According to still other embodiments, the flame retardant filler component 120 may be a glass frit filler. According to still other embodiments, the flame retardant filler component 120 may be an alkaline salt filler. According to yet other embodiments, the flame retardant filler component 120 may be a vermiculite filler. According to still other embodiments, the flame retardant filler component 120 may be a filler of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 120 may be selected from an particular group of metal hydrate materials. For example, the flame retardant filler component 120 may be selected from a group consisting of aluminum trihydrate, magnesium dihydroxides, boehmite, calcium hydroxide, Huntite, gypsum, hydromagnesite, and any combination thereof.

According to still other embodiments, the flame retardant filler component 120 may include a particular metal hydrate material. For example, the flame retardant filler component 120 may include aluminum trihydrate. According to still other embodiments, the flame retardant filler component 120 may include magnesium dihydroxides. According to yet other embodiments, the flame retardant filler component 120 may include boehmite. According to other embodiments, the flame retardant filler component 120 may include calcium hydroxide. According to still other embodiments, the flame retardant filler component 120 may include Huntite. According to yet other embodiments, the flame retardant filler component 120 may include gypsum. According to other embodiments, the flame retardant filler component 120 may include hydromagnesite. According to still other embodiments, the flame retardant filler component 120 may include any combination of aluminum trihydrate, magnesium dihydroxides, boehmite, calcium hydroxide, Huntite, gypsum, or hydromagnesite.

According to still other embodiments, the flame retardant filler component 120 may consist of a particular metal hydrate material. For example, the flame retardant filler component 120 may consist of aluminum trihydrate. According to still other embodiments, the flame retardant filler component 120 may consist of magnesium dihydroxides. According to yet other embodiments, the flame retardant filler component 120 may consist of boehmite. According to other embodiments, the flame retardant filler component 120 may consist of calcium hydroxide. According to still other embodiments, the flame retardant filler component 120 may consist of Huntite. According to yet other embodiments, the flame retardant filler component 120 may consist of gypsum. According to other embodiments, the flame retardant filler component 120 may consist of hydromagnesite. According to still other embodiments, the flame retardant filler component 120 may consist of any combination of aluminum trihydrate, magnesium dihydroxides, boehmite, calcium hydroxide, Huntite, gypsum, or hydromagnesite.

According to still other embodiments, the flame retardant filler component 120 may be a particular metal hydrate material filler. For example, the flame retardant filler component 120 may be an aluminum trihydrate filler. According to still other embodiments, the flame retardant filler component 120 may be a magnesium dihydroxide filler. According to yet other embodiments, the flame retardant filler component 120 may be a boehmite filler. According to other embodiments, the flame retardant filler component 120 may be a calcium hydroxide filler. According to still other embodiments, the flame retardant filler component 120 may be a Huntite filler. According to yet other embodiments, the flame retardant filler component 120 may be a gypsum filler. According to other embodiments, the flame retardant filler component 120 may be a hydromagnesite filler. According to still other embodiments, the flame retardant filler component 120 may be a filler of any combination of aluminum trihydrate, magnesium dihydroxides, boehmite, calcium hydroxide, Huntite, gypsum, or hydromagnesite.

According to still other embodiments, the flame retardant filler component 120 may be selected from a particular group of borate salt materials. For example, the flame retardant filler component 120 may be selected from a group consisting of zinc borate, calcium borate, sodium borate, potassium borate, lithium borate, and any combination thereof.

According to still other embodiments, the flame retardant filler component 120 may include a particular borate salt material. For example, the flame retardant filler component 120 may include zinc borate. According to yet other embodiments, the flame retardant filler component 120 may include calcium borate. According to other embodiments, the flame retardant filler component 120 may include sodium borate. According to still other embodiments, the flame retardant filler component 120 may include potassium borate. According to yet other embodiments, the flame retardant filler component 120 may include lithium borate. According to still other embodiments, the flame retardant filler component 120 may include any combination of zinc borate, calcium borate, sodium borate, potassium borate, or lithium borate.

According to still other embodiments, the flame retardant filler component 120 may consist of a particular borate salt material. For example, the flame retardant filler component 120 may consist of zinc borate. According to yet other embodiments, the flame retardant filler component 120 may consist of calcium borate. According to other embodiments, the flame retardant filler component 120 may consist of sodium borate. According to still other embodiments, the flame retardant filler component 120 may consist of potassium borate. According to yet other embodiments, the flame retardant filler component 120 may consist of lithium borate. According to still other embodiments, the flame retardant filler component 120 may consist of any combination of zinc borate, calcium borate, sodium borate, potassium borate, or lithium borate.

According to still other embodiments, the flame retardant filler component 120 may be a particular borate salt material filler. For example, the flame retardant filler component 120 may be a zinc borate filler. According to yet other embodiments, the flame retardant filler component 120 may be a calcium borate filler. According to other embodiments, the flame retardant filler component 120 may be a sodium borate filler. According to still other embodiments, the flame retardant filler component 120 may be a potassium borate filler. According to yet other embodiments, the flame retardant filler component 120 may be a lithium borate filler. According to still other embodiments, the flame retardant filler component 120 may be a filler of any combination of zinc borate, calcium borate, sodium borate, potassium borate, or lithium borate.

According to still other embodiments, the flame retardant filler component 120 may be selected from a particular group of platinum compound materials. For example, the flame retardant filler component 120 may be selected from a group consisting of platinum-1,3-divinyl-1,1,3,3-tetramethyldisiloxane, hexachloroplatinic acid, and any combination thereof.

According to still other embodiments, the flame retardant filler component 120 may include a particular of platinum compound material. For example, the flame retardant filler component 120 may include platinum-1,3-divinyl-1,1,3,3-tetramethyldisiloxane. According to yet other embodiments, the flame retardant filler component 120 may include hexachloroplatinic acid. According to still other embodiments, the flame retardant filler component 120 may include any combination of platinum-1,3-divinyl-1,1,3,3-tetramethyldisiloxane, and hexachloroplatinic acid.

According to still other embodiments, the flame retardant filler component 120 may consist of a particular of platinum compound material. For example, the flame retardant filler component 120 may consist of platinum-1,3-divinyl-1,1,3,3-tetramethyldisiloxane. According to yet other embodiments, the flame retardant filler component 120 may consist of hexachloroplatinic acid. According to still other embodiments, the flame retardant filler component 120 may consist of any combination of platinum-1,3-divinyl-1,1,3,3-tetramethyldisiloxane, and hexachloroplatinic acid.

According to still other embodiments, the flame retardant filler component 120 may be a particular platinum compound material filler. For example, the flame retardant filler component 120 may be a platinum-1,3-divinyl-1,1,3,3-tetramethyldisiloxane filler. According to yet other embodiments, the flame retardant filler component 120 may be a hexachloroplatinic acid filler. According to still other embodiments, the flame retardant filler component 120 may be a filler or any combination of platinum-1,3-divinyl-1,1,3,3-tetramethyldisiloxane, and hexachloroplatinic acid.

According to still other embodiments, the flame retardant filler component 120 may be selected from a particular group of transition metal oxide materials. For example, the flame retardant filler component 120 may be selected from a group consisting of iron oxide, cerium oxide, titanium oxide, zinc oxide, and any combination thereof.

According to still other embodiments, the flame retardant filler component 120 may include a particular transition metal oxide material. For example, the flame retardant filler component 120 may include iron oxide. According to yet other embodiments, the flame retardant filler component 120 may include cerium oxide. According to other embodiments, the flame retardant filler component 120 may include zinc oxide. According to still other embodiments, the flame retardant filler component 120 may include any combination of iron oxide, cerium oxide, titanium oxide, or zinc oxide.

According to still other embodiments, the flame retardant filler component 120 may consist of a particular transition metal oxide material. For example, the flame retardant filler component 120 may consist of iron oxide. According to yet other embodiments, the flame retardant filler component 120 may consist of cerium oxide. According to other embodiments, the flame retardant filler component 120 may consist of zinc oxide. According to still other embodiments, the flame retardant filler component 120 may consist of any combination of iron oxide, cerium oxide, titanium oxide, or zinc oxide.

According to still other embodiments, the flame retardant filler component 120 may be a particular transition metal oxide material filler. For example, the flame retardant filler component 120 may be an iron oxide filler. According to yet other embodiments, the flame retardant filler component 120 may be a cerium oxide filler. According to other embodiments, the flame retardant filler component 120 may be a zinc oxide filler. According to still other embodiments, the flame retardant filler component 120 may be a filler of any combination of iron oxide, cerium oxide, titanium oxide, or zinc oxide.

According to still other embodiments, the flame retardant filler component 120 may be selected from a particular group of metal carbonate materials. For example, the flame retardant filler component 120 may be selected from a group consisting of Huntite, calcium carbonate, and any combination thereof.

According to still other embodiments, the flame retardant filler component 120 may include a particular transition metal carbonate material. For example, the flame retardant filler component 120 may include Huntite. According to yet other embodiments, the flame retardant filler component 120 may include calcium carbonate. According to still other embodiments, the flame retardant filler component 120 may include any combination of Huntite, or calcium carbonate.

According to still other embodiments, the flame retardant filler component 120 may consist of a particular transition metal carbonate material. For example, the flame retardant filler component 120 may consist of Huntite. According to yet other embodiments, the flame retardant filler component 120 may consist of calcium carbonate. According to still other embodiments, the flame retardant filler component 120 may consist of any combination of Huntite, or calcium carbonate.

According to still other embodiments, the flame retardant filler component 120 may be a particular transition metal carbonate material filler. For example, the flame retardant filler component 120 may be a Huntite filler. According to yet other embodiments, the flame retardant filler component 120 may be a calcium carbonate filler. According to still other embodiments, the flame retardant filler component 120 may be a filler of any combination of Huntite, or calcium carbonate.

According to still other embodiments, the flame retardant filler component 120 may be selected from a particular group of metal carbonate mixtures. For example, the flame retardant filler component 120 may be selected from a group consisting of a natural mixture of hydromagnesite and Huntite, synthetic magnesium carbonate hydroxide pentahydrate, and any combination thereof.

According to still other embodiments, the flame retardant filler component 120 may include a particular metal carbonate mixtures. For example, the flame retardant filler component 120 may include a natural mixture of hydromagnesite. According to other embodiments, the flame retardant filler component 120 may include a natural mixture of hydromagnesite. According to still other embodiments, the flame retardant filler component 120 may include any combination of a natural mixture of hydromagnesite and Huntite, or synthetic magnesium carbonate hydroxide pentahydrate.

According to still other embodiments, the flame retardant filler component 120 may consist of a particular metal carbonate mixtures. For example, the flame retardant filler component 120 may consist of a natural mixture of hydromagnesite. According to other embodiments, the flame retardant filler component 120 may consist of a natural mixture of hydromagnesite. According to still other embodiments, the flame retardant filler component 120 may consist of any combination of a natural mixture of hydromagnesite and Huntite, or synthetic magnesium carbonate hydroxide pentahydrate.

According to still other embodiments, the flame retardant filler component 120 may be a particular metal carbonate mixture filler. For example, the flame retardant filler component 120 may be a filler of a natural mixture of hydromagnesite. According to other embodiments, the flame retardant filler component 120 may be a filler of a natural mixture of hydromagnesite. According to still other embodiments, the flame retardant filler component 120 may be a filler of any combination of a natural mixture of hydromagnesite and Huntite, or synthetic magnesium carbonate hydroxide pentahydrate.

According to still other embodiments, the flame retardant filler component 120 may be selected from a particular group of alumina silicate materials or magnesium silicate materials. For example, the flame retardant filler component 120 may be selected from a group consisting of wallastonite, mica, kaolin, clay, talc, vermiculite, and any combination thereof.

According to still other embodiments, the flame retardant filler component 120 may include a particular alumina silicate material or magnesium silicate material. For example, the flame retardant filler component 120 may include wallastonite. According to yet other embodiments, the flame retardant filler component 120 may include mica. According to still other embodiments, the flame retardant filler component 120 may include clay. According to other embodiments, the flame retardant filler component 120 may include kaolin. According to yet other embodiments, the flame retardant filler component 120 may include a talc. According to other embodiments, the flame retardant filler component 120 may include vermiculite. According to still other embodiments, the flame retardant filler component 120 may include any combination of wallastonite, mica, clay, kaolin, talc, or vermiculite.

According to still other embodiments, the flame retardant filler component 120 may consist of a particular alumina silicate material or magnesium silicate material. For example, the flame retardant filler component 120 may consist of wallastonite. According to yet other embodiments, the flame retardant filler component 120 may consist of mica. According to still other embodiments, the flame retardant filler component 220 may consist of clay. According to other embodiments, the flame retardant filler component 120 may consist of kaolin. According to yet other embodiments, the flame retardant filler component 120 may consist of talc. According to other embodiments, the flame retardant filler component 120 may consist of vermiculite. According to still other embodiments, the flame retardant filler component 120 may consist of any combination of wallastonite, mica, clay, kaolin, talc, or vermiculite.

According to still other embodiments, the flame retardant filler component 120 may be a filler of a particular alumina silicate material or magnesium silicate material. For example, the flame retardant filler component 120 may be a wallastonite filler. According to yet other embodiments, the flame retardant filler component 120 may be a mica filler. According to still other embodiments, the flame retardant filler component 220 may be a clay filler. According to other embodiments, the flame retardant filler component 120 may be a kaolin filler. According to yet other embodiments, the flame retardant filler component 120 may be a talc filler. According to other embodiments, the flame retardant filler component 120 may be a vermiculite filler. According to still other embodiments, the flame retardant filler component 120 may be a filler of any combination of wallastonite, mica, clay, kaolin, talc, or vermiculite.

According to still other embodiments, the flame retardant filler component 120 may be selected from a particular group of alkaline salt materials. For example, the flame retardant filler component 120 may be selected from a group consisting of sodium carbonate, potassium carbonate, and any combination thereof.

According to still other embodiments, the flame retardant filler component 120 may include a particular alkaline salt material. For example, the flame retardant filler component 120 may include sodium carbonate. According to yet other embodiments, the flame retardant filler component 120 may include potassium carbonate. According to still other embodiments, the flame retardant filler component 120 may include any combination of sodium carbonate, or potassium carbonate.

According to still other embodiments, the flame retardant filler component 120 may consist of a particular alkaline salt material. For example, the flame retardant filler component 120 may consist of sodium carbonate. According to yet other embodiments, the flame retardant filler component 120 may consist of potassium carbonate. According to still other embodiments, the flame retardant filler component 120 may consist of any combination of sodium carbonate, or potassium carbonate.

According to still other embodiments, the flame retardant filler component 120 may be a particular alkaline salt material filler. For example, the flame retardant filler component 120 may be a sodium carbonate filler. According to yet other embodiments, the flame retardant filler component 120 may be a potassium carbonate filler. According to still other embodiments, the flame retardant filler component 120 may be a filler of any combination of sodium carbonate, or potassium carbonate.

According to still other embodiments, the insulation filler component 130 may be selected from a particular group of materials. For example, the insulation filler component 130 may be selected from a group consisting of expanded perlite, unexpanded perlite, glass beads, vermiculite, expanded vermiculite, expanded glass, zeolite, aerogel, silica, porous silica, porous alumina, and any combination thereof.

According to still other embodiments, the insulation filler component 130 may include a particular material. For example, the insulation filler component 130 may include expanded perlite. According to yet other embodiments, the insulation filler component 130 may include unexpanded perlite. According to yet other embodiments, the insulation filler component 130 may include glass beads. According to yet other embodiments, the insulation filler component 130 may include vermiculite. According to yet other embodiments, the insulation filler component 130 may include expanded vermiculite. According to yet other embodiments, the insulation filler component 130 may include expanded glass. According to yet other embodiments, the insulation filler component 130 may include zeolite. According to still other embodiments, the insulation filler component 130 may include aerogel. According to yet other embodiments, the insulation filler component 130 may include silica. According to yet other embodiments, the insulation filler component 130 may include porous silica. According to other embodiments, the insulation filler component 130 may include porous alumina. According to still other embodiments, the insulation filler component 130 may include any combination of expanded perlite, unexpanded perlite, glass beads, vermiculite, expanded vermiculite, expanded glass, zeolite, aerogel, silica, porous silica, or porous alumina.

According to still other embodiments, the insulation filler component 130 may consist of a particular material. For example, the insulation filler component 130 may consist of expanded perlite. According to yet other embodiments, the insulation filler component 130 may consist of unexpanded perlite. According to yet other embodiments, the insulation filler component 130 may consist of glass beads. According to yet other embodiments, the insulation filler component 130 may consist of vermiculite. According to yet other embodiments, the insulation filler component 130 may consist of expanded vermiculite. According to yet other embodiments, the insulation filler component 130 may consist of expanded glass. According to yet other embodiments, the insulation filler component 130 may consist of zeolite. According to still other embodiments, the insulation filler component 130 may consist of aerogel. According to yet other embodiments, the insulation filler component 130 may consist of silica. According to yet other embodiments, the insulation filler component 130 may consist of porous silica. According to other embodiments, the insulation filler component 130 may consist of porous alumina. According to still other embodiments, the insulation filler component 130 may consist of any combination of expanded perlite, unexpanded perlite, glass beads, vermiculite, expanded vermiculite, expanded glass, zeolite, aerogel, silica, porous silica, or porous alumina.

According to still other embodiments, the insulation filler component 130 may be a filler of a particular material. For example, the insulation filler component 130 may be an expanded perlite filler. According to yet other embodiments, the insulation filler component 130 may be an unexpanded perlite filler. According to yet other embodiments, the insulation filler component 130 may be a glass beads filler. According to yet other embodiments, the insulation filler component 130 may be a vermiculite filler. According to yet other embodiments, the insulation filler component 130 may be an expanded vermiculite filler. According to yet other embodiments, the insulation filler component 130 may be an expanded glass filler. According to yet other embodiments, the flame retardant filler component 220 may be a zeolite filler. According to still other embodiments, the insulation filler component 130 may be an aerogel filler. According to yet other embodiments, the insulation filler component 130 may be a silica filler. According to yet other embodiments, the insulation filler component 130 may be a porous silica filler. According to other embodiments, the insulation filler component 130 may be a porous alumina filler. According to still other embodiments, the insulation filler component 130 may be a filler of any combination of expanded perlite, unexpanded perlite, glass beads, vermiculite, expanded vermiculite, expanded glass, zeolite, aerogel, silica, porous silica, or porous alumina.

According to certain embodiments, the first foam layer 104 may include a particular content of the silicone-based matrix component 110. For example, the first foam layer 104 may include a silicone-based matrix component content of at least about 20 wt. % for a total weight of the first foam layer 104, such as, at least about 25 wt. % or at least about 30 wt. % or at least about 35 wt. % or at least about 40 wt. % or at least about 45 wt. % or even at least about 50 wt. %. According to yet other embodiments, the first foam layer 104 may include a silicone-based matrix component content of not greater than about 85 wt. % for a total weight of the first foam layer 104, such as, not greater than about 80 wt. % or not greater than about 75 wt. % or not greater than about 70 wt. % or even not greater than about 65 wt. %. It will be appreciated that the silicone-based matrix component content of the first foam layer 104 may be within a range between any of the values noted above. It will be further appreciated that the silicone-based matrix component content of the first foam layer 104 may be any value between any of the minimum and maximum values noted above.

According to still other embodiments, the first foam layer 104 may include a particular content of flame retardant filler component 120. For example, the first foam layer 104 may include a flame retardant filler component content of at least about 1 wt. % for a total weight of the first foam layer 104, such as, at least about 2 wt. %, or at least about 3 wt. %, or at least about 4 wt. %, or at least about 5 wt. %, or at least about 7 wt. %, or at least about 10 wt. %, or at least about 12 wt. %, or even at least about 15.%. According to yet other embodiments, the first foam layer 104 may include a flame retardant filler component content of not greater than about 35 wt. % for a total weight of the first foam layer 104, such as, not greater than about 34 wt. %, or not greater than about 33 wt. %, or not greater than about 32 wt. %, or not greater than about 31 wt. %, or not greater than about 30 wt. %, or not greater than about 28 wt. %, or not greater than about 25 wt. %, or not greater than about 23 wt. %, or not greater than about 20 wt. %. It will be appreciated that the flame retardant filler component content of the first foam layer 104 may be within a range between any of the values noted above. It will be further appreciated that the flame retardant filler component content of the first foam layer 104 may be any value between any of the minimum and maximum values noted above.

According to still other embodiments, the first foam layer 104 may include a particular content of insulation filler component 120. For example, the first foam layer 104 may include an insulation filler component content of at least about 1 wt. % for a total weight of the first foam layer 104, such as, at least about 2 wt. %, or at least about 3 wt. %, or at least about 4 wt. %, or at least about 5 wt. %, or at least about 7 wt. %, or at least about 10 wt. %, or at least about 12 wt. %, or even at least about 15.%. According to yet other embodiments, the first foam layer 104 may include an insulation filler component content of not greater than about 25 wt. % for a total weight of the first foam layer 104, such as, not greater than about 24 wt. % or not greater than about 23 wt. %, or not greater than about 22 wt. %, or not greater than about 21 wt. %, or not greater than about 20 wt. %, or not greater than about 19 wt. %, or not greater than about 18 wt. %, or not greater than about 17 wt. %, or not greater than about 16 wt. %. It will be appreciated that the insulation filler component content of the first foam layer 104 may be within a range between any of the values noted above. It will be further appreciated that the insulation filler component content of the first foam layer 104 may be any value between any of the minimum and maximum values noted above.

According to certain embodiments, the first foam layer 104 may have a particular flammability rating as measured according to ASTM D4986. In particular, the foam layer may have a HBF flammability rating as measured according to ASTM D4986.

According to certain embodiments, the first foam layer 104 may have a particular flammability rating as measured according to ASTM D3801. In particular, the foam layer may have a V-0 flammability rating as measured according to ASTM D3801.

According to certain embodiments, the multilayer composite 100 may have a particular flammability rating as measured according to ASTM D4986. In particular, the foam layer may have a HBF flammability rating as measured according to ASTM D4986.

According to certain embodiments, the multilayer composite 100 may have a particular flammability rating as measured according to ASTM D3801. In particular, the foam layer may have a V-0 flammability rating as measured according to ASTM D3801.

According to yet other embodiments, the first foam layer 104 may have a particular self-ignition time when exposed to a hot plate test at a temperature of 650° C. For purposes of embodiments described herein, the hot plate test is carried out by preparing a 1-inch by 1-inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the first foam layer 104 may have a self-ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self-ignition time of the first foam layer 104 may be within a range between any of the values noted above. It will be further appreciated that the self-ignition time of the first foam layer 104 may be any value between any of the values noted above.

According to yet other embodiments, the multilayer composite 100 may have a particular self-ignition time when exposed to a hot plate test at a temperature of 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the multilayer composite 100 may have a self-ignition time of at least about 1 minute, such as, at least about 1.5 minutes, or at least about 2 minutes, or at least about 2.5 minutes, or at least about 3 minutes, or at least about 3.5 minutes, or at least about 4.0 minutes, or at least about 4.5 minutes, or even at least about 5.0 minutes. It will be appreciated that the self-ignition time of the multilayer composite 100 may be within a range between any of the values noted above. It will be further appreciated that the self-ignition time of the multilayer composite 100 may be any value between any of the values noted above.

According to still other embodiments, the first foam layer 104 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the first foam layer 104 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the first foam layer 104 may have a cold side temperature of at least about 25° C. It will be appreciated that the cold side temperature of the first foam layer 104 may be within a range between any of the values noted above. It will be further appreciated that the cold side temperature of the first foam layer 104 may be any value between any of the values noted above.

According to still other embodiments, the multilayer composite 100 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the multilayer composite 100 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the multilayer composite 100 may have a cold side temperature of at least about 25° C. It will be appreciated that the cold side temperature of the multilayer composite 100 may be within a range between any of the values noted above. It will be further appreciated that the cold side temperature of the multilayer composite 100 may be any value between any of the values noted above.

According to still other embodiments, the multilayer composite 100 may have a particular burn-through time as measured when exposed to a torch test carried out at a temperature of 1000° C. For purposes of embodiments described herein, the torch test is carried out by preparing a 1 inch by 1 inch specimen of the material, which is placed 1.5 inches from a torch. The thermal couple is fixed on the flame side to measure the “hot side” temperature, which is adjusted to 1000° C. A second thermal couple is positioned to the opposite side of the sample to measure the “cold side” temperature. The time is measured until, if it occurs, the torch burns through the sample. According to particular embodiments, the multilayer composite 100 may have a burn-through time of at least about 6 minutes, such as, at least about 6.5 minutes, or at least about 7 minutes, or at least about 7.5 minutes, or at least about 8 minutes, or at least about 8.5 minutes, or at least about 9.0 minutes, or at least about 9.5 minutes, or even at least about 10.0 minutes. It will be appreciated that the burn-through time of the multilayer composite 100 may be within a range between any of the values noted above. It will be further appreciated that the burn-through time of the multilayer composite 100 may be any value between any of the values noted above.

According to yet other embodiments, the first foam layer 104 may have a particular thickness. For example, the first foam layer 104 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the first foam layer 104 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the first foam layer 104 may be within a range between any of the minimum and maximum values noted above. It will be further appreciated that the thickness of the first foam layer 104 may be any value between any of the minimum and maximum values noted above.

According to yet other embodiments, the multilayer composite 100 may have a particular thickness. For example, the multilayer composite 100 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the multilayer composite 100 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the multilayer composite 100 may be within a range between any of the minimum and maximum values noted above. It will be further appreciated that the thickness of the multilayer composite 100 may be any value between any of the minimum and maximum values noted above.

According to yet other embodiments, the first foam layer 104 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the first foam layer 104 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the first foam layer 104 may have a 25% strain compression rating of at least about 5 kPa, such as, at least about 10 kPa or at least about 15 kPa or at least about 20 kPa or at least about 25 kPa. It will be appreciated that the 25% strain compression rating of the first foam layer 104 may be within a range between any of the minimum and maximum values noted above. It will be further appreciated that the 50% strain compression rating of the first foam layer 104 may be any value between any of the minimum and maximum values noted above.

According to yet other embodiments, the multilayer composite 100 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the multilayer composite 100 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the multilayer composite 100 may have a 25% strain compression rating of at least about 5 kPa, such as, at least about 10 kPa or at least about 15 kPa or at least about 20 kPa or at least about 25 kPa. It will be appreciated that the 25% strain compression rating of the multilayer composite 100 may be within a range between any of the minimum and maximum values noted above. It will be further appreciated that the 50% strain compression rating of the multilayer composite 100 may be any value between any of the minimum and maximum values noted above.

According to yet other embodiments, the first foam layer 104 may have a particular density. For purpose of embodiments described herein, the density of the first foam layer 104 may be determined according to ASTM D1056. According to certain embodiments, the first foam layer 104 may have a density of not greater than about 1200 kg/m³, such as, not great than about 1175 kg/m³ or not greater than about 1150 kg/m³ or not greater than about 1125 kg/m³ or not greater than about 1100 kg/m³ or not greater than about 1050 kg/m³ or not greater than about 1000 kg/m³ or not greater than about 950 kg/m³ or not greater than about 900 kg/m³ or not greater than about 850 kg/m³ or not greater than about 800 kg/m³ or not greater than about 750 kg/m³ or not greater than about 700 kg/m³ or even not greater than about 650 kg/m³. According to yet other embodiments, the first foam layer 104 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the first foam layer 104 may be within a range between any of the minimum and maximum values noted above. It will be further appreciated that the density of the first foam layer 104 may be any value between any of the minimum and maximum values noted above.

According to yet other embodiments, the multilayer composite 100 may have a particular density. For the purpose of embodiments described herein, the density of the first foam layer 104 may be determined according to ASTM D1056. According to certain embodiments, the multilayer composite 100 may have a density of not greater than about 1500 kg/m³, such as, not great than about 1475 kg/m³ or not greater than about 1450 kg/m³ or not greater than about 1425 kg/m³ or not greater than about 1400 kg/m³ or not greater than about 1350 kg/m³ or not greater than about 1300 kg/m³ or not greater than about 1250 kg/m³ or not greater than about 1200 kg/m³ or not greater than about 1150 kg/m³ or not greater than about 1100 kg/m³ or not greater than about 1050 kg/m³ or not greater than about 1000 kg/m³ or even not greater than about 950 kg/m³. According to yet other embodiments, the multilayer composite 100 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the multilayer composite 100 may be within a range between any of the minimum and maximum values noted above. It will be further appreciated that the density of the multilayer composite 100 may be any value between any of the minimum and maximum values noted above.

According to yet other embodiments, the first foam layer 104 may have a particular thermal conductivity as measured according to ASTM C518. For example, the first foam layer 104 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the first foam layer 104 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the first foam layer 104 may be within a range between any of the minimum and maximum values noted above. It will be further appreciated that the thermal conductivity of the first foam layer 104 may be any value between any of the minimum and maximum values noted above.

According to yet other embodiments, the multilayer composite 100 may have a particular thermal conductivity as measured according to ASTM C518. For example, the multilayer composite 100 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the multilayer composite 100 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the multilayer composite 100 may be within a range between any of the minimum and maximum values noted above. It will be further appreciated that the thermal conductivity of the multilayer composite 100 may be any value between any of the minimum and maximum values noted above.

According to still other embodiments, the first barrier layer 102 may be a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof.

According to still other embodiments, the first barrier layer 102 may include a particular material. For example, the first barrier layer 102 may include mica. According to still other embodiments, the first barrier layer 102 may include a mica-fiber glass fabric. According to yet other embodiments, the first barrier layer 102 may include a glass fabric. According to other embodiments, the first barrier layer 102 may include a silica fabric. According to still other embodiments, the first barrier layer 102 may include a basalt fabric. According to yet other embodiments, the first barrier layer 102 may include a vermiculite coated glass fabric. According to other embodiments, the first barrier layer 102 may include an aerogel. According to yet other embodiments, the first barrier layer 102 may include a non-woven glass fabric. According to still other embodiments, the first barrier layer 102 may include any combination of mica, a mica-fiber glass fabric, a glass fabric, a silica fabric, a basalt fabric, a vermiculite coated glass fabric, an aerogel, or a non-woven glass fabric. According to yet other embodiments, the first barrier layer 102 may include any lamination of mica, a mica-fiber glass fabric, a glass fabric, a silica fabric, a basalt fabric, a vermiculite coated glass fabric, an aerogel, or a non-woven glass fabric.

According to still other embodiments, the first barrier layer 102 may consist of a particular material. For example, the first barrier layer 102 may consist of mica. According to still other embodiments, the first barrier layer 102 may consist of a mica-fiber glass fabric. According to yet other embodiments, the first barrier layer 102 may consist of a glass fabric. According to other embodiments, the first barrier layer 102 may consist of a silica fabric. According to still other embodiments, the first barrier layer 102 may consist of a basalt fabric. According to yet other embodiments, the first barrier layer 102 may consist of a vermiculite coated glass fabric. According to other embodiments, the first barrier layer 102 may consist of an aerogel. According to yet other embodiments, the first barrier layer 102 may consist of a non-woven glass fabric. According to still other embodiments, the first barrier layer 102 may consist of any combination of mica, a mica-fiber glass fabric, a glass fabric, a silica fabric, a basalt fabric, a vermiculite coated glass fabric, an aerogel, or a non-woven glass fabric. According to yet other embodiments, the first barrier layer 102 may consist of any lamination of mica, a mica-fiber glass fabric, a glass fabric, a silica fabric, a basalt fabric, a vermiculite coated glass fabric, an aerogel, or a non-woven glass fabric.

According to still other embodiments, the first barrier layer 102 may be a particular material layer. For example, the first barrier layer 102 may be a mica layer. According to still other embodiments, the first barrier layer 102 may be a mica-fiber glass fabric layer. According to yet other embodiments, the first barrier layer 102 may be a glass fabric layer. According to other embodiments, the first barrier layer 102 may be a silica fabric layer. According to still other embodiments, the first barrier layer 102 may be a basalt fabric layer. According to yet other embodiments, the first barrier layer 102 may be a vermiculite coated glass fabric layer. According to other embodiments, the first barrier layer 102 may be an aerogel layer. According to yet other embodiments, the first barrier layer 102 may be a non-woven glass fabric layer. According to still other embodiments, the first barrier layer 102 may be a layer of any combination of mica, a mica-fiber glass fabric, a glass fabric, a silica fabric, a basalt fabric, a vermiculite coated glass fabric, an aerogel, or a non-woven glass fabric. According to yet other embodiments, the first barrier layer 102 may be a layer of any lamination of mica, a mica-fiber glass fabric, a glass fabric, a silica fabric, a basalt fabric, a vermiculite coated glass fabric, an aerogel, or a non-woven glass fabric.

According to yet other embodiments, the first barrier layer 102 may have a particular thickness. For example, the first barrier layer 102 may have a thickness of at least about 0.05 mm, such as, at least about 0.1 mm or at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.1 mm or at least about 1.2 mm or at least about 1.3 mm or even at least about 1.4 mm. According to still other embodiments, the first barrier layer 102 may have a thickness of not greater than about 7 mm, such as, not greater than about 6.5 mm or not greater than about 6.0 mm or not greater than about 5.5 mm or not greater than about 5.0 mm or not greater than about 4.5 mm or not greater than about 4.0 mm or not greater than about 3.5 mm or not greater than about 3.0 mm or not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or even not greater than about 2.2 mm. It will be appreciated that the thickness of the first barrier layer 102 may be within a range between any of the minimum and maximum values noted above. It will be further appreciated that the thickness of the first barrier layer 102 may be any value between any of the minimum and maximum values noted above.

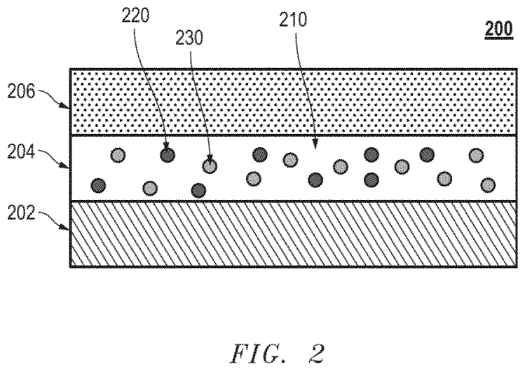

FIG. 2 shows another multilayer composite 200 according to embodiments described herein. As shown in FIG. 2, the multilayer composite 200 may include a first barrier layer 202, a first foam layer 204, and a second barrier layer 206. The first foam layer 204 may include a silicone-based matrix component 210, a flame retardant filler component 220, and an insulation filler component 230.

It will be appreciated that the multilayer composite 200 and all components described in reference to the multilayer composite 200 as shown in FIG. 2 may have any of the characteristics described herein with reference to corresponding components in FIG. 1. In particular, the characteristics of the multilayer composite 200, the first barrier layer 202, the first foam layer 204, the silicone-based matrix component 210, the flame retardant filler component 220, and the insulation filler component 230 shown in FIG. 2 may have any of the corresponding characteristics described herein in reference to multilayer composite 100, the first barrier layer 102, the first foam layer 104, the silicone-based matrix component 110, the flame retardant filler component 120, and the insulation filler component 130 shown in FIG. 1, respectively.

According to still other embodiments, the second barrier layer 206 may be a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof.

According to still other embodiments, the second barrier layer 206 may include a particular material. For example, the second barrier layer 206 may include mica. According to still other embodiments, the second barrier layer 206 may include a mica-fiber glass fabric. According to yet other embodiments, the second barrier layer 206 may include a glass fabric. According to other embodiments, the second barrier layer 206 may include a silica fabric. According to still other embodiments, the second barrier layer 206 may include a basalt fabric. According to yet other embodiments, the second barrier layer 206 may include a vermiculite coated glass fabric. According to other embodiments, the second barrier layer 206 may include an aerogel. According to yet other embodiments, the second barrier layer 206 may include a non-woven glass fabric. According to still other embodiments, the second barrier layer 206 may include any combination of mica, a mica-fiber glass fabric, a glass fabric, a silica fabric, a basalt fabric, a vermiculite coated glass fabric, an aerogel, or a non-woven glass fabric. According to yet other embodiments, the second barrier layer 206 may include any lamination of mica, a mica-fiber glass fabric, a glass fabric, a silica fabric, a basalt fabric, a vermiculite coated glass fabric, an aerogel, or a non-woven glass fabric.

According to still other embodiments, the second barrier layer 206 may consist of a particular material. For example, the second barrier layer 206 may consist of mica. According to still other embodiments, the second barrier layer 206 may consist of a mica-fiber glass fabric. According to yet other embodiments, the second barrier layer 206 may consist of a glass fabric. According to other embodiments, the second barrier layer 206 may consist of a silica fabric. According to still other embodiments, the second barrier layer 206 may consist of a basalt fabric. According to yet other embodiments, the second barrier layer 206 may consist of a vermiculite coated glass fabric. According to other embodiments, the second barrier layer 206 may consist of an aerogel. According to yet other embodiments, the second barrier layer 206 may consist of a non-woven glass fabric. According to still other embodiments, the second barrier layer 206 may consist of any combination of mica, a mica-fiber glass fabric, a glass fabric, a silica fabric, a basalt fabric, a vermiculite coated glass fabric, an aerogel, or a non-woven glass fabric. According to yet other embodiments, the second barrier layer 206 may consist of any lamination of mica, a mica-fiber glass fabric, a glass fabric, a silica fabric, a basalt fabric, a vermiculite coated glass fabric, an aerogel, or a non-woven glass fabric.

According to still other embodiments, the second barrier layer 206 may be a particular material layer. For example, the second barrier layer 206 may be a mica layer. According to still other embodiments, the second barrier layer 206 may be a mica-fiber glass fabric layer. According to yet other embodiments, the second barrier layer 206 may be a glass fabric layer. According to other embodiments, the second barrier layer 206 may be a silica fabric layer. According to still other embodiments, the second barrier layer 206 may be a basalt fabric layer. According to yet other embodiments, the second barrier layer 206 may be a vermiculite coated glass fabric layer. According to other embodiments, the second barrier layer 206 may be an aerogel layer. According to yet other embodiments, the second barrier layer 206 may be a non-woven glass fabric layer. According to still other embodiments, the second barrier layer 206 may be a layer of any combination of mica, a mica-fiber glass fabric, a glass fabric, a silica fabric, a basalt fabric, a vermiculite coated glass fabric, an aerogel, or a non-woven glass fabric. According to yet other embodiments, the second barrier layer 206 may be a layer of any lamination of mica, a mica-fiber glass fabric, a glass fabric, a silica fabric, a basalt fabric, a vermiculite coated glass fabric, an aerogel, or a non-woven glass fabric.

According to yet other embodiments, the second barrier layer 206 may have a particular thickness. For example, the second barrier layer 206 may have a thickness of at least about 0.05 mm, such as, at least about 0.1 mm or at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.1 mm or at least about 1.2 mm or at least about 1.3 mm or even at least about 1.4 mm. According to still other embodiments, the second barrier layer 206 may have a thickness of not greater than about 3 7 mm, such as, not greater than about 6.5 mm or not greater than about 6.0 mm or not greater than about 5.5 mm or not greater than about 5.0 mm or not greater than about 4.5 mm or not greater than about 4.0 mm or no not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or even not greater than about 2.2 mm. It will be appreciated that the thickness of the second barrier layer 206 may be within a range between any of the minimum and maximum values noted above. It will be further appreciated that the thickness of the second barrier layer 206 may be any value between any of the minimum and maximum values noted above.

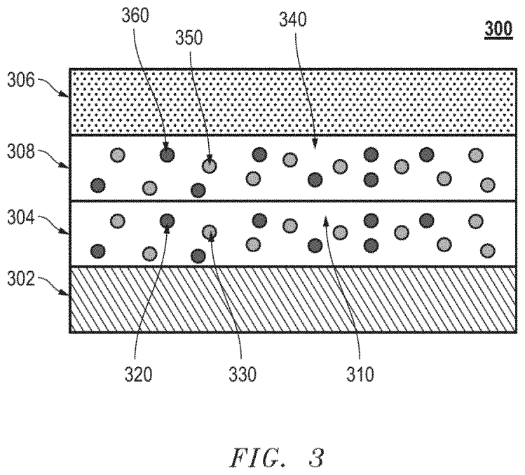

FIG. 3 shows another multilayer composite 300 according to embodiments described herein. As shown in FIG. 3, the multilayer composite 300 may include a first barrier layer 302, a first foam layer 304, a second foam layer 308, and a second barrier layer 306. The first foam layer 304 may include a silicone-based matrix component 310, a flame retardant filler component 320, and an insulation filler component 330. The second foam layer 308 may include a silicone-based matrix component 340, a flame retardant filler component 350, and an insulation filler component 360. As shown in FIG. 3, the first foam layer 304 and the second foam layer 308 are both between the first barrier layer 302 and the second barrier layer 308.

It will be appreciated that the multilayer composite 300 and all components described in reference to the multilayer composite 200 as shown in FIG. 2 may have any of the characteristics described herein with reference to corresponding components in FIG. 1 and/or FIG. 2. In particular, the characteristics of the multilayer composite 300, the first barrier layer 302, the first foam layer 304, the second barrier layer 306, the silicone-based matrix component 310, the flame retardant filler component 320, and the insulation filler component 330 shown in FIG. 3 may have any of the corresponding characteristics described herein in reference to multilayer composite 100 (200), the first barrier layer 102 (202), the first foam layer 104 (204), the silicone-based matrix component 110 (210), the flame retardant filler component 120 (220), and the insulation filler component 130 (230) shown in FIG. 1 (FIG. 2), respectively.

According to particular embodiments, the silicone-based matrix component 340 of the second foam layer 308 may include platinum catalyzed addition cured silicone foam. According to still other embodiments, the silicone-based matrix component 340 may include peroxide cured silicone foam. According to yet other embodiments, the silicone-based matrix component 340 may include tin catalyzed silicone foam. According to still other embodiments, the silicone-based matrix component 340 may include any combination of a platinum catalyzed addition cured silicone foam, a peroxide cured silicone foam, and a tin catalyzed silicone foam.

According to particular embodiments, the silicone-based matrix component 340 may consist of platinum catalyzed addition cured silicone foam. According to still other embodiments, the silicone-based matrix component 340 may consist of peroxide cured silicone foam. According to yet other embodiments, the silicone-based matrix component 340 may consist of tin catalyzed silicone foam. According to still other embodiments, the silicone-based matrix component 340 may consist of any combination of a platinum catalyzed addition cured silicone foam, a peroxide cured silicone foam, and a tin catalyzed silicone foam.

According to particular embodiments, the silicone-based matrix component 340 may be a platinum catalyzed addition cured silicone foam layer. According to still other embodiments, the silicone-based matrix component 340 may be a peroxide cured silicone foam layer. According to yet other embodiments, the silicone-based matrix component 340 may be a tin catalyzed silicone foam layer. According to still other embodiments, the silicone-based matrix component 340 may be a layer of any combination of a platinum catalyzed addition cured silicone foam, a peroxide cured silicone foam, and a tin catalyzed silicone foam.

According to yet other embodiments, the flame retardant filler component 350 may be selected from a particular group of materials. For example, the flame retardant filler component 350 may be selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

According to still other embodiments, the flame retardant filler component 350 may include a particular material. For example, the flame retardant filler component 350 may include metal hydrates. According to still other embodiments, the flame retardant filler component 350 may include borate compounds. According to still other embodiments, the flame retardant filler component 350 may include platinum compounds. According to still other embodiments, the flame retardant filler component 350 may include transition metal oxides. According to other embodiments, the flame retardant filler component 350 may include metal carbonates. According to still other embodiments, the flame retardant filler component 350 may include calcium silicates. According to yet other embodiments, the flame retardant filler component 350 may include aluminum silicates. According to yet other embodiments, the flame retardant filler component 350 may include magnesium silicates. According to still other embodiments, the flame retardant filler component 350 may include glass frits. According to still other embodiments, the flame retardant filler component 350 may include alkaline salts. According to yet other embodiments, the flame retardant filler component 350 may include vermiculites. According to still other embodiments, the flame retardant filler component 350 may include any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 350 may consist of a particular material. For example, the flame retardant filler component 350 may consist of metal hydrates. According to still other embodiments, the flame retardant filler component 350 may consist of borate compounds. According to still other embodiments, the flame retardant filler component 350 may consist of platinum compounds. According to still other embodiments, the flame retardant filler component 350 may consist of transition metal oxides. According to other embodiments, the flame retardant filler component 350 may consist of metal carbonates. According to still other embodiments, the flame retardant filler component 350 may consist of calcium silicates. According to yet other embodiments, the flame retardant filler component 350 may consist of aluminum silicates. According to yet other embodiments, the flame retardant filler component 350 may consist of magnesium silicates. According to still other embodiments, the flame retardant filler component 350 may consist of glass frits. According to still other embodiments, the flame retardant filler component 350 may consist of alkaline salts. According to yet other embodiments, the flame retardant filler component 350 may consist of vermiculites. According to still other embodiments, the flame retardant filler component 350 may consist of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 350 may be a particular material. For example, the flame retardant filler component 350 may be a metal hydrate filler. According to still other embodiments, the flame retardant filler component 350 may be a borate salt filler. According to still other embodiments, the flame retardant filler component 350 may be a platinum compound filler. According to still other embodiments, the flame retardant filler component 350 may be a transition metal oxide filler. According to other embodiments, the flame retardant filler component 350 may be a metal carbonate filler. According to still other embodiments, the flame retardant filler component 350 may be a calcium silicate filler. According to yet other embodiments, the flame retardant filler component 350 may be an aluminum silicate filler. According to yet other embodiments, the flame retardant filler component 350 may be a magnesium silicate filler. According to still other embodiments, the flame retardant filler component 350 may be a glass frit filler. According to still other embodiments, the flame retardant filler component 350 may be an alkaline salt filler. According to yet other embodiments, the flame retardant filler component 350 may be a vermiculite filler. According to still other embodiments, the flame retardant filler component 350 may be a filler of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 350 may be selected from a particular group of metal hydrate materials. For example, the flame retardant filler component 350 may be selected from a group consisting of aluminum trihydrate, magnesium dihydroxides, boehmite, calcium hydroxide, Huntite, gypsum, hydromagnesite, and any combination thereof.

According to still other embodiments, the flame retardant filler component 350 may include a particular metal hydrate material. For example, the flame retardant filler component 350 may include aluminum trihydrate. According to still other embodiments, the flame retardant filler component 350 may include magnesium dihydroxides. According to yet other embodiments, the flame retardant filler component 350 may include boehmite. According to other embodiments, the flame retardant filler component 350 may include calcium hydroxide. According to still other embodiments, the flame retardant filler component 350 may include Huntite. According to yet other embodiments, the flame retardant filler component 350 may include gypsum. According to other embodiments, the flame retardant filler component 350 may include hydromagnesite. According to still other embodiments, the flame retardant filler component 350 may include any combination of aluminum trihydrate, magnesium dihydroxides, boehmite, calcium hydroxide, Huntite, gypsum, or hydromagnesite.

According to still other embodiments, the flame retardant filler component 350 may consist of a particular metal hydrate material. For example, the flame retardant filler component 350 may consist of aluminum trihydrate. According to still other embodiments, the flame retardant filler component 350 may consist of magnesium dihydroxides. According to yet other embodiments, the flame retardant filler component 350 may consist of boehmite. According to other embodiments, the flame retardant filler component 350 may consist of calcium hydroxide. According to still other embodiments, the flame retardant filler component 350 may consist of Huntite. According to yet other embodiments, the flame retardant filler component 350 may consist of gypsum. According to other embodiments, the flame retardant filler component 350 may consist of hydromagnesite. According to still other embodiments, the flame retardant filler component 350 may consist of any combination of aluminum trihydrate, magnesium dihydroxides, boehmite, calcium hydroxide, Huntite, gypsum, or hydromagnesite.

According to still other embodiments, the flame retardant filler component 350 may be a particular metal hydrate material filler. For example, the flame retardant filler component 350 may be an aluminum trihydrate filler. According to still other embodiments, the flame retardant filler component 350 may be a magnesium dihydroxide filler. According to yet other embodiments, the flame retardant filler component 350 may be a boehmite filler. According to other embodiments, the flame retardant filler component 350 may be a calcium hydroxide filler. According to still other embodiments, the flame retardant filler component 350 may be a Huntite filler. According to yet other embodiments, the flame retardant filler component 350 may be a gypsum filler. According to other embodiments, the flame retardant filler component 350 may be a hydromagnesite filler. According to still other embodiments, the flame retardant filler component 350 may be a filler of any combination of aluminum trihydrate, magnesium dihydroxides, boehmite, calcium hydroxide, Huntite, gypsum, or hydromagnesite.

According to still other embodiments, the flame retardant filler component 350 may be selected from a particular group of borate salt materials. For example, the flame retardant filler component 350 may be selected from a group consisting of zinc borate, calcium borate, sodium borate, potassium borate, lithium borate, and any combination thereof.

According to still other embodiments, the flame retardant filler component 350 may include a particular borate salt material. For example, the flame retardant filler component 350 may include zinc borate. According to yet other embodiments, the flame retardant filler component 350 may include calcium borate. According to other embodiments, the flame retardant filler component 350 may include sodium borate. According to still other embodiments, the flame retardant filler component 350 may include potassium borate. According to yet other embodiments, the flame retardant filler component 350 may include lithium borate. According to still other embodiments, the flame retardant filler component 350 may include any combination of zinc borate, calcium borate, sodium borate, potassium borate, or lithium borate.

According to still other embodiments, the flame retardant filler component 350 may consist of a particular borate salt material. For example, the flame retardant filler component 350 may consist of zinc borate. According to yet other embodiments, the flame retardant filler component 350 may consist of calcium borate. According to other embodiments, the flame retardant filler component 350 may consist of sodium borate. According to still other embodiments, the flame retardant filler component 350 may consist of potassium borate. According to yet other embodiments, the flame retardant filler component 350 may consist of lithium borate. According to still other embodiments, the flame retardant filler component 350 may consist of any combination of zinc borate, calcium borate, sodium borate, potassium borate, or lithium borate.

According to still other embodiments, the flame retardant filler component 350 may be a particular borate salt material filler. For example, the flame retardant filler component 350 may be a zinc borate filler. According to yet other embodiments, the flame retardant filler component 350 may be a calcium borate filler. According to other embodiments, the flame retardant filler component 350 may be a sodium borate filler. According to still other embodiments, the flame retardant filler component 350 may be a potassium borate filler. According to yet other embodiments, the flame retardant filler component 350 may be a lithium borate filler. According to still other embodiments, the flame retardant filler component 350 may be a filler of any combination of zinc borate, calcium borate, sodium borate, potassium borate, or lithium borate.

According to still other embodiments, the flame retardant filler component 350 may be selected from a particular group of platinum compound materials. For example, the flame retardant filler component 350 may be selected from a group consisting of platinum-1,3-divinyl-1,1,3,3-tetramethyldisiloxane, hexachloroplatinic acid, and any combination thereof.

According to still other embodiments, the flame retardant filler component 350 may include a particular of platinum compound material. For example, the flame retardant filler component 350 may include platinum-1,3-divinyl-1,1,3,3-tetramethyldisiloxane. According to yet other embodiments, the flame retardant filler component 350 may include hexachloroplatinic acid. According to still other embodiments, the flame retardant filler component 350 may include any combination of platinum-1,3-divinyl-1,1,3,3-tetramethyldisiloxane, and hexachloroplatinic acid.

According to still other embodiments, the flame retardant filler component 350 may consist of a particular of platinum compound material. For example, the flame retardant filler component 350 may consist of platinum-1,3-divinyl-1,1,3,3-tetramethyldisiloxane. According to yet other embodiments, the flame retardant filler component 350 may consist of hexachloroplatinic acid. According to still other embodiments, the flame retardant filler component 350 may consist of any combination of platinum-1,3-divinyl-1,1,3,3-tetramethyldisiloxane, and hexachloroplatinic acid.

According to still other embodiments, the flame retardant filler component 350 may be a particular platinum compound material filler. For example, the flame retardant filler component 350 may be a platinum-1,3-divinyl-1,1,3,3-tetramethyldisiloxane filler. According to yet other embodiments, the flame retardant filler component 350 may be a hexachloroplatinic acid filler. According to still other embodiments, the flame retardant filler component 350 may be a filler or any combination of platinum-1,3-divinyl-1,1,3,3-tetramethyldisiloxane, and hexachloroplatinic acid.

According to still other embodiments, the flame retardant filler component 350 may be selected from a particular group of transition metal oxide materials. For example, the flame retardant filler component 350 may be selected from a group consisting of iron oxide, cerium oxide, titanium oxide, zinc oxide, and any combination thereof.

According to still other embodiments, the flame retardant filler component 350 may include a particular transition metal oxide material. For example, the flame retardant filler component 350 may include iron oxide. According to yet other embodiments, the flame retardant filler component 350 may include cerium oxide. According to other embodiments, the flame retardant filler component 350 may include zinc oxide. According to still other embodiments, the flame retardant filler component 350 may include any combination of iron oxide, cerium oxide, titanium oxide, or zinc oxide.

According to still other embodiments, the flame retardant filler component 350 may consist of a particular transition metal oxide material. For example, the flame retardant filler component 350 may consist of iron oxide. According to yet other embodiments, the flame retardant filler component 350 may consist of cerium oxide. According to other embodiments, the flame retardant filler component 350 may consist of zinc oxide. According to still other embodiments, the flame retardant filler component 350 may consist of any combination of iron oxide, cerium oxide, titanium oxide, or zinc oxide.

According to still other embodiments, the flame retardant filler component 350 may be a particular transition metal oxide material filler. For example, the flame retardant filler component 350 may be an iron oxide filler. According to yet other embodiments, the flame retardant filler component 350 may be a cerium oxide filler. According to other embodiments, the flame retardant filler component 350 may be a zinc oxide filler. According to still other embodiments, the flame retardant filler component 350 may be a filler of any combination of iron oxide, cerium oxide, titanium oxide, or zinc oxide.

According to still other embodiments, the flame retardant filler component 350 may be selected from a particular group of metal carbonate materials. For example, the flame retardant filler component 350 may be selected from a group consisting of Huntite, calcium carbonate, and any combination thereof.

According to still other embodiments, the flame retardant filler component 350 may include a particular transition metal carbonate material. For example, the flame retardant filler component 350 may include Huntite. According to yet other embodiments, the flame retardant filler component 350 may include calcium carbonate. According to still other embodiments, the flame retardant filler component 350 may include any combination of Huntite, or calcium carbonate.

According to still other embodiments, the flame retardant filler component 350 may consist of a particular transition metal carbonate material. For example, the flame retardant filler component 350 may consist of Huntite. According to yet other embodiments, the flame retardant filler component 350 may consist of calcium carbonate. According to still other embodiments, the flame retardant filler component 350 may consist of any combination of Huntite, or calcium carbonate.

According to still other embodiments, the flame retardant filler component 350 may be a particular transition metal carbonate material filler. For example, the flame retardant filler component 350 may be a Huntite filler. According to yet other embodiments, the flame retardant filler component 350 may be a calcium carbonate filler. According to still other embodiments, the flame retardant filler component 350 may be a filler of any combination of Huntite, or calcium carbonate.

According to still other embodiments, the flame retardant filler component 350 may be selected from a particular group of metal carbonate mixtures. For example, the flame retardant filler component 350 may be selected from a group consisting of a natural mixture of hydromagnesite and Huntite, synthetic magnesium carbonate hydroxide pentahydrate, and any combination thereof.

According to still other embodiments, the flame retardant filler component 350 may include a particular metal carbonate mixtures. For example, the flame retardant filler component 350 may include a natural mixture of hydromagnesite. According to other embodiments, the flame retardant filler component 350 may include a natural mixture of hydromagnesite. According to still other embodiments, the flame retardant filler component 350 may include any combination of a natural mixture of hydromagnesite and Huntite, or synthetic magnesium carbonate hydroxide pentahydrate.

According to still other embodiments, the flame retardant filler component 350 may consist of a particular metal carbonate mixtures. For example, the flame retardant filler component 350 may consist of a natural mixture of hydromagnesite. According to other embodiments, the flame retardant filler component 350 may consist of a natural mixture of hydromagnesite. According to still other embodiments, the flame retardant filler component 350 may consist of any combination of a natural mixture of hydromagnesite and Huntite, or synthetic magnesium carbonate hydroxide pentahydrate.

According to still other embodiments, the flame retardant filler component 350 may be a particular metal carbonate mixture filler. For example, the flame retardant filler component 350 may be a natural mixture of hydromagnesite. According to other embodiments, the flame retardant filler component 350 may be a filler of a natural mixture of hydromagnesite. According to still other embodiments, the flame retardant filler component 350 may be a filler of any combination of a natural mixture of hydromagnesite and Huntite, or synthetic magnesium carbonate hydroxide pentahydrate.

According to still other embodiments, the flame retardant filler component 350 may be selected from a particular group of alumina silicate materials or magnesium silicate materials. For example, the flame retardant filler component 350 may be selected from a group consisting of wallastonite, mica, clay, kaolin, talc, vermiculite, and any combination thereof.

According to still other embodiments, the flame retardant filler component 350 may include a particular alumina silicate material or magnesium silicate material. For example, the flame retardant filler component 350 may include wallastonite. According to yet other embodiments, the flame retardant filler component 350 may include mica. According to other embodiments, the flame retardant filler component 350 may include kaolin. According to yet other embodiments, the flame retardant filler component 350 may include a talc. According to other embodiments, the flame retardant filler component 350 may include vermiculite. According to still other embodiments, the flame retardant filler component 350 may include any combination of wallastonite, mica, clay, kaolin, talc, or vermiculite.

According to still other embodiments, the flame retardant filler component 350 may consist of a particular alumina silicate material or magnesium silicate material. For example, the flame retardant filler component 350 may consist of wallastonite. According to yet other embodiments, the flame retardant filler component 350 may consist of mica. According to other embodiments, the flame retardant filler component 350 may consist of kaolin. According to yet other embodiments, the flame retardant filler component 350 may consist of talc. According to other embodiments, the flame retardant filler component 350 may consist of vermiculite. According to still other embodiments, the flame retardant filler component 350 may consist of any combination of wallastonite, mica, clay, kaolin, talc, or vermiculite.

According to still other embodiments, the flame retardant filler component 350 may be a filler of a particular alumina silicate material or magnesium silicate material. For example, the flame retardant filler component 350 may be a wallastonite filler. According to yet other embodiments, the flame retardant filler component 350 may be a mica filler. According to other embodiments, the flame retardant filler component 350 may be a kaolin filler. According to yet other embodiments, the flame retardant filler component 350 may be a talc filler. According to other embodiments, the flame retardant filler component 350 may be a vermiculite filler. According to still other embodiments, the flame retardant filler component 350 may be a filler of any combination of wallastonite, mica, clay, kaolin, talc, or vermiculite.

According to still other embodiments, the flame retardant filler component 350 may be selected from a particular group of alkaline salt materials. For example, the flame retardant filler component 350 may be selected from a group consisting of sodium carbonate, potassium carbonate, and any combination thereof.

According to still other embodiments, the flame retardant filler component 350 may include a particular alkaline salt material. For example, the flame retardant filler component 350 may include sodium carbonate. According to yet other embodiments, the flame retardant filler component 350 may include potassium carbonate. According to still other embodiments, the flame retardant filler component 350 may include any combination of sodium carbonate, or potassium carbonate.

According to still other embodiments, the flame retardant filler component 350 may consist of a particular alkaline salt material. For example, the flame retardant filler component 350 may consist of sodium carbonate. According to yet other embodiments, the flame retardant filler component 350 may consist of potassium carbonate. According to still other embodiments, the flame retardant filler component 350 may consist of any combination of sodium carbonate, or potassium carbonate.

According to still other embodiments, the flame retardant filler component 350 may be a particular alkaline salt material filler. For example, the flame retardant filler component 350 may be a sodium carbonate filler. According to yet other embodiments, the flame retardant filler component 350 may be a potassium carbonate filler. According to still other embodiments, the flame retardant filler component 350 may be a filler of any combination of sodium carbonate, or potassium carbonate.

According to still other embodiments, the insulation filler component 360 may be selected from a particular group of materials. For example, the insulation filler component 360 may be selected from a group consisting of expanded perlite, unexpanded perlite, glass beads, vermiculite, expanded vermiculite, expanded glass, zeolite, aerogel, silica, porous silica, porous alumina, and any combination thereof.

According to still other embodiments, the insulation filler component 360 may include a particular material. For example, the insulation filler component 360 may include expanded perlite. According to yet other embodiments, the insulation filler component 360 may include unexpanded perlite. According to yet other embodiments, the insulation filler component 360 may include glass beads. According to yet other embodiments, the insulation filler component 360 may include vermiculite. According to yet other embodiments, the insulation filler component 360 may include expanded vermiculite. According to yet other embodiments, the insulation filler component 360 may include expanded glass. According to yet other embodiments, the insulation filler component 360 may include zeolite. According to still other embodiments, the insulation filler component 360 may include aerogel. According to yet other embodiments, the insulation filler component 360 may include silica. According to yet other embodiments, the insulation filler component 360 may include porous silica. According to other embodiments, the insulation filler component 360 may include porous alumina. According to still other embodiments, the insulation filler component 360 may include any combination of expanded perlite, unexpanded perlite, glass beads, vermiculite, expanded vermiculite, expanded glass, zeolite, aerogel, silica, porous silica, or porous alumina.

According to still other embodiments, the insulation filler component 360 may consist of a particular material. For example, the insulation filler component 360 may consist of expanded perlite. According to yet other embodiments, the insulation filler component 360 may consist of unexpanded perlite. According to yet other embodiments, the insulation filler component 360 may consist of glass beads. According to yet other embodiments, the insulation filler component 360 may consist of vermiculite. According to yet other embodiments, the insulation filler component 360 may consist of expanded vermiculite. According to yet other embodiments, the insulation filler component 360 may consist of expanded glass. According to yet other embodiments, the insulation filler component 360 may consist of zeolite. According to still other embodiments, the insulation filler component 360 may consist of aerogel. According to yet other embodiments, the insulation filler component 360 may consist of silica. According to yet other embodiments, the insulation filler component 360 may consist of porous silica. According to other embodiments, the insulation filler component 360 may consist of porous alumina. According to still other embodiments, the insulation filler component 360 may consist of any combination of expanded perlite, unexpanded perlite, glass beads, vermiculite, expanded vermiculite, expanded glass, zeolite, aerogel, silica, porous silica, or porous alumina.

According to still other embodiments, the insulation filler component 360 may be a filler of a particular material. For example, the insulation filler component 360 may be an expanded perlite filler. According to yet other embodiments, the insulation filler component 360 may be an unexpanded perlite filler. According to yet other embodiments, the insulation filler component 360 may be a glass beads filler. According to yet other embodiments, the insulation filler component 360 may be a vermiculite filler. According to yet other embodiments, the insulation filler component 360 may be an expanded vermiculite filler. According to yet other embodiments, the insulation filler component 360 may be an expanded glass filler. According to yet other embodiments, the flame retardant filler component 220 may be a zeolite filler. According to still other embodiments, the insulation filler component 360 may be an aerogel filler. According to yet other embodiments, the insulation filler component 360 may be a silica filler. According to yet other embodiments, the insulation filler component 360 may be a porous silica filler. According to other embodiments, the insulation filler component 360 may be a porous alumina filler. According to still other embodiments, the insulation filler component 360 may be a filler of any combination of expanded perlite, unexpanded perlite, glass beads, vermiculite, expanded vermiculite, expanded glass, zeolite, aerogel, silica, porous silica, or porous alumina.

According to certain embodiments, the second foam layer 308 may include a particular content of the silicone-based matrix component 340. For example, the second foam layer 308 may include a silicone-based matrix component content of at least about 20 wt. % for a total weight of the second foam layer 308, such as, at least about 25 wt. % or at least about 30 wt. % or at least about 35 wt. % or at least about 40 wt. % or at least about 45 wt. % or even at least about 50 wt. %. According to yet other embodiments, the second foam layer 308 may include a silicone-based matrix component content of not greater than about 85 wt. % for a total weight of the second foam layer 308, such as, not greater than about 80 wt. % or not greater than about 75 wt. % or not greater than about 70 wt. % or even not greater than about 65 wt. %. It will be appreciated that the silicone-based matrix component content of the second foam layer 308 may be within a range between any of the values noted above. It will be further appreciated that the silicone-based matrix component content of the second foam layer 308 may be any value between any of the minimum and maximum values noted above.

According to still other embodiments, the second foam layer 308 may include a particular content of flame retardant filler component 350. For example, the second foam layer 308 may include a flame retardant filler component content of at least about 1 wt. % for a total weight of the second foam layer 308, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the second foam layer 308 may include a flame retardant filler component content of not greater than about 35 wt. % for a total weight of the second foam layer 308, such as, not greater than about 34 wt. % or not greater than about 33 wt. % or not greater than about 32 wt. % or not greater than about 31 wt. % or not greater than about 30 wt. % or not greater than about 28 wt. % or not greater than about 25 wt. % or not greater than about 23 wt. % or not great than about 20 wt. %. It will be appreciated that the flame retardant filler component content of the second foam layer 308 may be within a range between any of the values noted above. It will be further appreciated that the flame retardant filler component content of the second foam layer 308 may be any value between any of the minimum and maximum values noted above.

According to still other embodiments, the second foam layer 308 may include a particular content of insulation filler component 350. For example, the second foam layer 308 may include an insulation filler component content of at least about 1 wt. % for a total weight of the second foam layer 308, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the second foam layer 308 may include an insulation filler component content of not greater than about 25 wt. % for a total weight of the second foam layer 308, such as, not greater than about 24 wt. % or not greater than about 23 wt. % or not greater than about 22 wt. % or not greater than about 21 wt. % or not greater than about 20 wt. % or not greater than about 19 wt. % or not greater than about 18 wt. % or not greater than about 17 wt. % or not great than about 16 wt. %. It will be appreciated that the insulation filler component content of the second foam layer 308 may be within a range between any of the values noted above. It will be further appreciated that the insulation filler component content of the second foam layer 308 may be any value between any of the minimum and maximum values noted above.

According to certain embodiments, the second foam layer 308 may have a particular flammability rating as measured according to ASTM D4986. In particular, the foam layer may have a HBF flammability rating as measured according to ASTM D4986.

According to certain embodiments, the second foam layer 308 may have a particular flammability rating as measured according to ASTM D3801. In particular, the foam layer may have a V-0 flammability rating as measured according to ASTM D3801.

According to yet other embodiments, the second foam layer 308 may have a particular self-ignition time when exposed to a hot plate test at a temperature of 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the second foam layer 308 may have a self-ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self-ignition time of the second foam layer 308 may be within a range between any of the values noted above. It will be further appreciated that the self-ignition time of the second foam layer 308 may be any value between any of the values noted above.

According to still other embodiments, the second foam layer 308 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the second foam layer 308 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the second foam layer 308 may have a cold side temperature of at least about 25° C. It will be appreciated that the cold side temperature of the second foam layer 308 may be within a range between any of the values noted above. It will be further appreciated that the cold side temperature of the second foam layer 308 may be any value between any of the values noted above.

According to yet other embodiments, the second foam layer 308 may have a particular thickness. For example, the second foam layer 308 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the second foam layer 308 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the second foam layer 308 may be within a range between any of the minimum and maximum values noted above. It will be further appreciated that the thickness of the second foam layer 308 may be any value between any of the minimum and maximum values noted above.

According to yet other embodiments, the second foam layer 308 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the second foam layer 308 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the second foam layer 308 may have a 25% strain compression rating of at least about 5 kPa, such as, at least about 10 kPa or at least about 15 kPa or at least about 20 kPa or at least about 25 kPa. It will be appreciated that the 25% strain compression rating of the second foam layer 308 may be within a range between any of the minimum and maximum values noted above. It will be further appreciated that the 50% strain compression rating of the second foam layer 308 may be any value between any of the minimum and maximum values noted above.

According to yet other embodiments, the second foam layer 308 may have a particular density. For the purpose of embodiments described herein, the density of the second foam layer 308 may be determined according to ASTM D1056. According to certain embodiments, the second foam layer 308 may have a density of not greater than about 1200 kg/m³, such as, not great than about 1175 kg/m³ or not greater than about 1150 kg/m³ or not greater than about 1125 kg/m³ or not greater than about 1100 kg/m³ or not greater than about 1050 kg/m³ or not greater than about 1000 kg/m³ or not greater than about 950 kg/m³ or not greater than about 900 kg/m³ or not greater than about 850 kg/m³ or not greater than about 800 kg/m³ or not greater than about 750 kg/m³ or not greater than about 700 kg/m³ or even not greater than about 650 kg/m³. According to yet other embodiments, the second foam layer 308 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the second foam layer 308 may be within a range between any of the minimum and maximum values noted above. It will be further appreciated that the density of the second foam layer 308 may be any value between any of the minimum and maximum values noted above.

According to yet other embodiments, the second foam layer 308 may have a particular thermal conductivity as measured according to ASTM C518. For example, the second foam layer 308 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the second foam layer 308 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the second foam layer 308 may be within a range between any of the minimum and maximum values noted above. It will be further appreciated that the thermal conductivity of the second foam layer 308 may be any value between any of the minimum and maximum values noted above.

According to certain embodiments, multilayer composites described herein may be formed according to any acceptable forming process for a multilayer composite. According to a particular embodiment, the multilayer composite may be formed using a lamination process where the porous foam and barrier layer are laminated using a transfer adhesive such as, for example, a silicon adhesive, a rubber adhesive, an acrylic adhesive, a phenolic adhesive, a polyurethane-based adhesive or any combination thereof. According to still other embodiments, the multilayer composite may be formed using a lamination process with a porous foam and a coated barrier layer, where the coating on the barrier layer is an adhesive, such as, a silicon adhesive, a rubber adhesive, an acrylic adhesive, a phenolic adhesive, a polyurethane-based adhesive or any combination thereof. According to still other embodiments, the multilayer composite may be formed using a direct cast forming process, wherein the foam is directly cast onto the barrier films or between the barrier films.

Tuning now to additional embodiments described herein, such embodiments are generally directed to a thermal barrier composite that may include a first barrier layer and a first foam layer. According to particular embodiments, the first foam layer may include a silicone-based matrix component, a flame retardant filler component, and an insulation filler component. According to still other embodiments, the thermal barrier composite may demonstrate a combination of improved performance in flame resistance and compression.

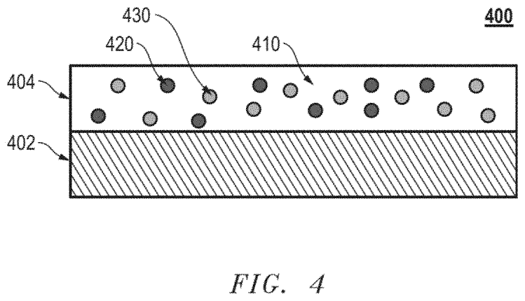

For purposes of illustration, FIG. 4 shows a thermal barrier composite 400 according to embodiments described herein. As shown in FIG. 4, a thermal barrier composite 400 may include a first barrier layer 402 and a first foam layer 404. The first foam layer 404 may include a silicone-based matrix component 410, a flame retardant filler component 420, and an insulation filler component 430.

According to particular embodiments, the silicone-based matrix component 410 of the first foam layer 404 may include platinum catalyzed addition cured silicone foam. According to still other embodiments, the silicone-based matrix component 410 may include peroxide cured silicone foam. According to yet other embodiments, the silicone-based matrix component 410 may include tin catalyzed silicone foam. According to still other embodiments, the silicone-based matrix component 410 may include any combination of a platinum catalyzed addition cured silicone foam, a peroxide cured silicone foam, and a tin catalyzed silicone foam.

According to particular embodiments, the silicone-based matrix component 410 may consist of platinum catalyzed addition cured silicone foam. According to still other embodiments, the silicone-based matrix component 410 may consist of peroxide cured silicone foam. According to yet other embodiments, the silicone-based matrix component 410 may consist of tin catalyzed silicone foam. According to still other embodiments, the silicone-based matrix component 410 may consist of any combination of a platinum catalyzed addition cured silicone foam, a peroxide cured silicone foam, and a tin catalyzed silicone foam.

According to particular embodiments, the silicone-based matrix component 410 may be a platinum catalyzed addition cured silicone foam layer. According to still other embodiments, the silicone-based matrix component 410 may be a peroxide cured silicone foam layer. According to yet other embodiments, the silicone-based matrix component 410 may be a tin catalyzed silicone foam layer. According to still other embodiments, the silicone-based matrix component 410 may be a layer of any combination of a platinum catalyzed addition cured silicone foam, a peroxide cured silicone foam, and a tin catalyzed silicone foam.

According to yet other embodiments, the flame retardant filler component 420 may be selected from a particular group of materials. For example, the flame retardant filler component 420 may be selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

According to still other embodiments, the flame retardant filler component 420 may include a particular material. For example, the flame retardant filler component 420 may include metal hydrates. According to still other embodiments, the flame retardant filler component 420 may include borate compounds. According to still other embodiments, the flame retardant filler component 420 may include platinum compounds. According to still other embodiments, the flame retardant filler component 420 may include transition metal oxides. According to other embodiments, the flame retardant filler component 420 may include metal carbonates. According to still other embodiments, the flame retardant filler component 420 may include calcium silicates. According to yet other embodiments, the flame retardant filler component 420 may include aluminum silicates. According to yet other embodiments, the flame retardant filler component 420 may include magnesium silicates. According to still other embodiments, the flame retardant filler component 420 may include glass frits. According to still other embodiments, the flame retardant filler component 420 may include alkaline salts. According to yet other embodiments, the flame retardant filler component 420 may include vermiculites. According to still other embodiments, the flame retardant filler component 420 may include any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 420 may consist of a particular material. For example, the flame retardant filler component 420 may consist of metal hydrates. According to still other embodiments, the flame retardant filler component 420 may consist of borate compounds. According to still other embodiments, the flame retardant filler component 420 may consist of platinum compounds. According to still other embodiments, the flame retardant filler component 420 may consist of transition metal oxides. According to other embodiments, the flame retardant filler component 420 may consist of metal carbonates. According to still other embodiments, the flame retardant filler component 420 may consist of calcium silicates. According to yet other embodiments, the flame retardant filler component 420 may consist of aluminum silicates. According to yet other embodiments, the flame retardant filler component 420 may consist of magnesium silicates. According to still other embodiments, the flame retardant filler component 420 may consist of glass frits. According to still other embodiments, the flame retardant filler component 420 may consist of alkaline salts. According to yet other embodiments, the flame retardant filler component 420 may consist of vermiculites. According to still other embodiments, the flame retardant filler component 420 may consist of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 420 may be a particular material. For example, the flame retardant filler component 420 may be a metal hydrate filler. According to still other embodiments, the flame retardant filler component 420 may be a borate salt filler. According to still other embodiments, the flame retardant filler component 420 may be a platinum compound filler. According to still other embodiments, the flame retardant filler component 420 may be a transition metal oxide filler. According to other embodiments, the flame retardant filler component 420 may be a metal carbonate filler. According to still other embodiments, the flame retardant filler component 420 may be a calcium silicate filler. According to yet other embodiments, the flame retardant filler component 420 may be an aluminum silicate filler. According to yet other embodiments, the flame retardant filler component 420 may be a magnesium silicate filler. According to still other embodiments, the flame retardant filler component 420 may be a glass frit filler. According to still other embodiments, the flame retardant filler component 420 may be an alkaline salt filler. According to yet other embodiments, the flame retardant filler component 420 may be a vermiculite filler. According to still other embodiments, the flame retardant filler component 420 may be a filler of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 420 may be selected from an particular group of metal hydrate materials. For example, the flame retardant filler component 420 may be selected from a group consisting of aluminum trihydrate, magnesium dihydroxides, boehmite, calcium hydroxide, Huntite, gypsum, hydromagnesite, and any combination thereof.

According to still other embodiments, the flame retardant filler component 420 may include a particular metal hydrate material. For example, the flame retardant filler component 420 may include aluminum trihydrate. According to still other embodiments, the flame retardant filler component 420 may include magnesium dihydroxides. According to yet other embodiments, the flame retardant filler component 420 may include boehmite. According to other embodiments, the flame retardant filler component 420 may include calcium hydroxide. According to still other embodiments, the flame retardant filler component 420 may include Huntite. According to yet other embodiments, the flame retardant filler component 420 may include gypsum. According to other embodiments, the flame retardant filler component 420 may include hydromagnesite. According to still other embodiments, the flame retardant filler component 420 may include any combination of aluminum trihydrate, magnesium dihydroxides, boehmite, calcium hydroxide, Huntite, gypsum, or hydromagnesite.

According to still other embodiments, the flame retardant filler component 420 may consist of a particular metal hydrate material. For example, the flame retardant filler component 420 may consist of aluminum trihydrate. According to still other embodiments, the flame retardant filler component 420 may consist of magnesium dihydroxides. According to yet other embodiments, the flame retardant filler component 420 may consist of boehmite. According to other embodiments, the flame retardant filler component 420 may consist of calcium hydroxide. According to still other embodiments, the flame retardant filler component 420 may consist of Huntite. According to yet other embodiments, the flame retardant filler component 420 may consist of gypsum. According to other embodiments, the flame retardant filler component 420 may consist of hydromagnesite. According to still other embodiments, the flame retardant filler component 420 may consist of any combination of aluminum trihydrate, magnesium dihydroxides, boehmite, calcium hydroxide, Huntite, gypsum, or hydromagnesite.

According to still other embodiments, the flame retardant filler component 420 may be a particular metal hydrate material filler. For example, the flame retardant filler component 420 may be an aluminum trihydrate filler. According to still other embodiments, the flame retardant filler component 420 may be a magnesium dihydroxide filler. According to yet other embodiments, the flame retardant filler component 420 may be a boehmite filler. According to other embodiments, the flame retardant filler component 420 may be a calcium hydroxide filler. According to still other embodiments, the flame retardant filler component 420 may be a Huntite filler. According to yet other embodiments, the flame retardant filler component 420 may be a gypsum filler. According to other embodiments, the flame retardant filler component 420 may be a hydromagnesite filler. According to still other embodiments, the flame retardant filler component 420 may be a filler of any combination of aluminum trihydrate, magnesium dihydroxides, boehmite, calcium hydroxide, Huntite, gypsum, or hydromagnesite.

According to still other embodiments, the flame retardant filler component 420 may be selected from a particular group of borate salt materials. For example, the flame retardant filler component 420 may be selected from a group consisting of zinc borate, calcium borate, sodium borate, potassium borate, lithium borate, and any combination thereof.

According to still other embodiments, the flame retardant filler component 420 may include a particular borate salt material. For example, the flame retardant filler component 420 may include zinc borate. According to yet other embodiments, the flame retardant filler component 420 may include calcium borate. According to other embodiments, the flame retardant filler component 420 may include sodium borate. According to still other embodiments, the flame retardant filler component 420 may include potassium borate. According to yet other embodiments, the flame retardant filler component 420 may include lithium borate. According to still other embodiments, the flame retardant filler component 420 may include any combination of zinc borate, calcium borate, sodium borate, potassium borate, or lithium borate.

According to still other embodiments, the flame retardant filler component 420 may consist of a particular borate salt material. For example, the flame retardant filler component 420 may consist of zinc borate. According to yet other embodiments, the flame retardant filler component 420 may consist of calcium borate. According to other embodiments, the flame retardant filler component 420 may consist of sodium borate. According to still other embodiments, the flame retardant filler component 420 may consist of potassium borate. According to yet other embodiments, the flame retardant filler component 420 may consist of lithium borate. According to still other embodiments, the flame retardant filler component 420 may consist of any combination of zinc borate, calcium borate, sodium borate, potassium borate, or lithium borate.

According to still other embodiments, the flame retardant filler component 420 may be a particular borate salt material filler. For example, the flame retardant filler component 420 may be a zinc borate filler. According to yet other embodiments, the flame retardant filler component 420 may be a calcium borate filler. According to other embodiments, the flame retardant filler component 420 may be a sodium borate filler. According to still other embodiments, the flame retardant filler component 420 may be a potassium borate filler. According to yet other embodiments, the flame retardant filler component 420 may be a lithium borate filler. According to still other embodiments, the flame retardant filler component 420 may be a filler of any combination of zinc borate, calcium borate, sodium borate, potassium borate, or lithium borate.

According to still other embodiments, the flame retardant filler component 420 may be selected from a particular group of platinum compound materials. For example, the flame retardant filler component 420 may be selected from a group consisting of platinum-1,3-divinyl-1,1,3,3-tetramethyldisiloxane, hexachloroplatinic acid, and any combination thereof.

According to still other embodiments, the flame retardant filler component 420 may include a particular of platinum compound material. For example, the flame retardant filler component 420 may include platinum-1,3-divinyl-1,1,3,3-tetramethyldisiloxane. According to yet other embodiments, the flame retardant filler component 420 may include hexachloroplatinic acid. According to still other embodiments, the flame retardant filler component 420 may include any combination of platinum-1,3-divinyl-1,1,3,3-tetramethyldisiloxane, and hexachloroplatinic acid.

According to still other embodiments, the flame retardant filler component 420 may consist of a particular of platinum compound material. For example, the flame retardant filler component 420 may consist of platinum-1,3-divinyl-1,1,3,3-tetramethyldisiloxane. According to yet other embodiments, the flame retardant filler component 420 may consist of hexachloroplatinic acid. According to still other embodiments, the flame retardant filler component 420 may consist of any combination of platinum-1,3-divinyl-1,1,3,3-tetramethyldisiloxane, and hexachloroplatinic acid.

According to still other embodiments, the flame retardant filler component 420 may be a particular platinum compound material filler. For example, the flame retardant filler component 420 may be a platinum-1,3-divinyl-1,1,3,3-tetramethyldisiloxane filler. According to yet other embodiments, the flame retardant filler component 420 may be a hexachloroplatinic acid filler. According to still other embodiments, the flame retardant filler component 420 may be a filler or any combination of platinum-1,3-divinyl-1,1,3,3-tetramethyldisiloxane, and hexachloroplatinic acid.

According to still other embodiments, the flame retardant filler component 420 may be selected from a particular group of transition metal oxide materials. For example, the flame retardant filler component 420 may be selected from a group consisting of iron oxide, cerium oxide, titanium oxide, zinc oxide, and any combination thereof.

According to still other embodiments, the flame retardant filler component 420 may include a particular transition metal oxide material. For example, the flame retardant filler component 420 may include iron oxide. According to yet other embodiments, the flame retardant filler component 420 may include cerium oxide. According to other embodiments, the flame retardant filler component 420 may include zinc oxide. According to still other embodiments, the flame retardant filler component 420 may include any combination of iron oxide, cerium oxide, titanium oxide, or zinc oxide.

According to still other embodiments, the flame retardant filler component 420 may consist of a particular transition metal oxide material. For example, the flame retardant filler component 420 may consist of iron oxide. According to yet other embodiments, the flame retardant filler component 420 may consist of cerium oxide. According to other embodiments, the flame retardant filler component 420 may consist of zinc oxide. According to still other embodiments, the flame retardant filler component 420 may consist of any combination of iron oxide, cerium oxide, titanium oxide, or zinc oxide.

According to still other embodiments, the flame retardant filler component 420 may be a particular transition metal oxide material filler. For example, the flame retardant filler component 420 may be an iron oxide filler. According to yet other embodiments, the flame retardant filler component 420 may be a cerium oxide filler. According to other embodiments, the flame retardant filler component 420 may be a zinc oxide filler. According to still other embodiments, the flame retardant filler component 420 may be a filler of any combination of iron oxide, cerium oxide, titanium oxide, or zinc oxide.

According to still other embodiments, the flame retardant filler component 420 may be selected from a particular group of metal carbonate materials. For example, the flame retardant filler component 420 may be selected from a group consisting of Huntite, calcium carbonate, and any combination thereof.

According to still other embodiments, the flame retardant filler component 420 may include a particular transition metal carbonate material. For example, the flame retardant filler component 420 may include Huntite. According to yet other embodiments, the flame retardant filler component 420 may include calcium carbonate. According to still other embodiments, the flame retardant filler component 420 may include any combination of Huntite, or calcium carbonate.

According to still other embodiments, the flame retardant filler component 420 may consist of a particular transition metal carbonate material. For example, the flame retardant filler component 420 may consist of Huntite. According to yet other embodiments, the flame retardant filler component 420 may consist of calcium carbonate. According to still other embodiments, the flame retardant filler component 420 may consist of any combination of Huntite, or calcium carbonate.

According to still other embodiments, the flame retardant filler component 420 may be a particular transition metal carbonate material filler. For example, the flame retardant filler component 420 may be a Huntite filler. According to yet other embodiments, the flame retardant filler component 420 may be a calcium carbonate filler. According to still other embodiments, the flame retardant filler component 420 may be a filler of any combination of Huntite, or calcium carbonate.

According to still other embodiments, the flame retardant filler component 420 may be selected from a particular group of metal carbonate mixtures. For example, the flame retardant filler component 420 may be selected from a group consisting of a natural mixture of hydromagnesite and Huntite, synthetic magnesium carbonate hydroxide pentahydrate, and any combination thereof.

According to still other embodiments, the flame retardant filler component 420 may include a particular metal carbonate mixtures. For example, the flame retardant filler component 420 may include a natural mixture of hydromagnesite. According to other embodiments, the flame retardant filler component 420 may include a natural mixture of hydromagnesite. According to still other embodiments, the flame retardant filler component 420 may include any combination of a natural mixture of hydromagnesite and Huntite, or synthetic magnesium carbonate hydroxide pentahydrate.

According to still other embodiments, the flame retardant filler component 420 may consist of a particular metal carbonate mixtures. For example, the flame retardant filler component 420 may consist of a natural mixture of hydromagnesite. According to other embodiments, the flame retardant filler component 420 may consist of a natural mixture of hydromagnesite. According to still other embodiments, the flame retardant filler component 420 may consist of any combination of a natural mixture of hydromagnesite and Huntite, or synthetic magnesium carbonate hydroxide pentahydrate.

According to still other embodiments, the flame retardant filler component 420 may be a particular metal carbonate mixture filler. For example, the flame retardant filler component 420 may be a filler of a natural mixture of hydromagnesite. According to other embodiments, the flame retardant filler component 420 may be a filler of a natural mixture of hydromagnesite. According to still other embodiments, the flame retardant filler component 420 may be a filler of any combination of a natural mixture of hydromagnesite and Huntite, or synthetic magnesium carbonate hydroxide pentahydrate.

According to still other embodiments, the flame retardant filler component 420 may be selected from a particular group of alumina silicate materials or magnesium silicate materials. For example, the flame retardant filler component 420 may be selected from a group consisting of wallastonite, mica, clay, kaolin, talc, vermiculite, and any combination thereof.

According to still other embodiments, the flame retardant filler component 420 may include a particular alumina silicate material or magnesium silicate material. For example, the flame retardant filler component 420 may include wallastonite. According to yet other embodiments, the flame retardant filler component 420 may include mica. According to still other embodiments, the flame retardant filler component 420 may include clay. According to other embodiments, the flame retardant filler component 420 may include kaolin. According to yet other embodiments, the flame retardant filler component 420 may include a talc. According to other embodiments, the flame retardant filler component 420 may include vermiculite. According to still other embodiments, the flame retardant filler component 420 may include any combination of wallastonite, mica, clay, kaolin, talc, or vermiculite.

According to still other embodiments, the flame retardant filler component 420 may consist of a particular alumina silicate material or magnesium silicate material. For example, the flame retardant filler component 420 may consist of wallastonite. According to yet other embodiments, the flame retardant filler component 420 may consist of mica. According to still other embodiments, the flame retardant filler component 420 may consist of clay. According to other embodiments, the flame retardant filler component 420 may consist of kaolin. According to yet other embodiments, the flame retardant filler component 420 may consist of talc. According to other embodiments, the flame retardant filler component 420 may consist of vermiculite. According to still other embodiments, the flame retardant filler component 420 may consist of any combination of wallastonite, mica, clay, kaolin, talc, or vermiculite.

According to still other embodiments, the flame retardant filler component 420 may be a filler of a particular alumina silicate material or magnesium silicate material. For example, the flame retardant filler component 420 may be a wallastonite filler. According to yet other embodiments, the flame retardant filler component 420 may be a mica filler. According to still other embodiments, the flame retardant filler component 420 may be a clay filler. According to other embodiments, the flame retardant filler component 420 may be a kaolin filler. According to yet other embodiments, the flame retardant filler component 420 may be a talc filler. According to other embodiments, the flame retardant filler component 420 may be a vermiculite filler. According to still other embodiments, the flame retardant filler component 420 may be a filler of any combination of wallastonite, mica, clay, kaolin, talc, or vermiculite.

According to still other embodiments, the flame retardant filler component 420 may be selected from a particular group of alkaline salt materials. For example, the flame retardant filler component 420 may be selected from a group consisting of sodium carbonate, potassium carbonate, and any combination thereof.

According to still other embodiments, the flame retardant filler component 420 may include a particular alkaline salt material. For example, the flame retardant filler component 420 may include sodium carbonate. According to yet other embodiments, the flame retardant filler component 420 may include potassium carbonate. According to still other embodiments, the flame retardant filler component 420 may include any combination of sodium carbonate, or potassium carbonate.

According to still other embodiments, the flame retardant filler component 420 may consist of a particular alkaline salt material. For example, the flame retardant filler component 420 may consist of sodium carbonate. According to yet other embodiments, the flame retardant filler component 420 may consist of potassium carbonate. According to still other embodiments, the flame retardant filler component 420 may consist of any combination of sodium carbonate, or potassium carbonate.

According to still other embodiments, the flame retardant filler component 420 may be a particular alkaline salt material filler. For example, the flame retardant filler component 420 may be a sodium carbonate filler. According to yet other embodiments, the flame retardant filler component 420 may be a potassium carbonate filler. According to still other embodiments, the flame retardant filler component 420 may be a filler of any combination of sodium carbonate, or potassium carbonate.

According to still other embodiments, the insulation filler component 430 may be selected from a particular group of materials. For example, the insulation filler component 430 may be selected from a group consisting of expanded perlite, unexpanded perlite, glass beads, vermiculite, expanded vermiculite, expanded glass, zeolite, aerogel, silica, porous silica, porous alumina, and any combination thereof.

According to still other embodiments, the insulation filler component 430 may include a particular material. For example, the insulation filler component 430 may include expanded perlite. According to yet other embodiments, the insulation filler component 430 may include unexpanded perlite. According to yet other embodiments, the insulation filler component 430 may include glass beads. According to yet other embodiments, the insulation filler component 430 may include vermiculite. According to yet other embodiments, the insulation filler component 430 may include expanded vermiculite. According to yet other embodiments, the insulation filler component 430 may include expanded glass. According to yet other embodiments, the insulation filler component 430 may include zeolite. According to still other embodiments, the insulation filler component 430 may include aerogel. According to yet other embodiments, the insulation filler component 430 may include silica. According to yet other embodiments, the insulation filler component 430 may include porous silica. According to other embodiments, the insulation filler component 430 may include porous alumina. According to still other embodiments, the insulation filler component 430 may include any combination of expanded perlite, unexpanded perlite, glass beads, vermiculite, expanded vermiculite, expanded glass, zeolite, aerogel, silica, porous silica, or porous alumina.

According to still other embodiments, the insulation filler component 430 may consist of a particular material. For example, the insulation filler component 430 may consist of expanded perlite. According to yet other embodiments, the insulation filler component 430 may consist of unexpanded perlite. According to yet other embodiments, the insulation filler component 430 may consist of glass beads. According to yet other embodiments, the insulation filler component 430 may consist of vermiculite. According to yet other embodiments, the insulation filler component 430 may consist of expanded vermiculite. According to yet other embodiments, the insulation filler component 430 may consist of expanded glass. According to yet other embodiments, the insulation filler component 430 may consist of zeolite. According to still other embodiments, the insulation filler component 430 may consist of aerogel. According to yet other embodiments, the insulation filler component 430 may consist of silica. According to yet other embodiments, the insulation filler component 430 may consist of porous silica. According to other embodiments, the insulation filler component 430 may consist of porous alumina. According to still other embodiments, the insulation filler component 430 may consist of any combination of expanded perlite, unexpanded perlite, glass beads, vermiculite, expanded vermiculite, expanded glass, zeolite, aerogel, silica, porous silica, or porous alumina.

According to still other embodiments, the insulation filler component 430 may be a filler of a particular material. For example, the insulation filler component 430 may be an expanded perlite filler. According to yet other embodiments, the insulation filler component 430 may be an unexpanded perlite filler. According to yet other embodiments, the insulation filler component 430 may be a glass beads filler. According to yet other embodiments, the insulation filler component 430 may be a vermiculite filler. According to yet other embodiments, the insulation filler component 430 may be an expanded vermiculite filler. According to yet other embodiments, the insulation filler component 430 may be an expanded glass filler. According to yet other embodiments, the flame retardant filler component 220 may be a zeolite filler. According to still other embodiments, the insulation filler component 430 may be an aerogel filler. According to yet other embodiments, the insulation filler component 430 may be a silica filler. According to yet other embodiments, the insulation filler component 430 may be a porous silica filler. According to other embodiments, the insulation filler component 430 may be a porous alumina filler. According to still other embodiments, the insulation filler component 430 may be a filler of any combination of expanded perlite, unexpanded perlite, glass beads, vermiculite, expanded vermiculite, expanded glass, zeolite, aerogel, silica, porous silica, or porous alumina.

According to certain embodiments, the first foam layer 404 may include a particular content of the silicone-based matrix component 410. For example, the first foam layer 404 may include a silicone-based matrix component content of at least about 20 wt. % for a total weight of the first foam layer 404, such as, at least about 25 wt. % or at least about 30 wt. % or at least about 35 wt. % or at least about 40 wt. % or at least about 45 wt. % or even at least about 50 wt. %. According to yet other embodiments, the first foam layer 404 may include a silicone-based matrix component content of not greater than about 85 wt. % for a total weight of the first foam layer 404, such as, not greater than about 80 wt. % or not greater than about 75 wt. % or not greater than about 70 wt. % or even not greater than about 65 wt. %. It will be appreciated that the silicone-based matrix component content of the first foam layer 404 may be within a range between any of the values noted above. It will be further appreciated that the silicone-based matrix component content of the first foam layer 404 may be any value between any of the minimum and maximum values noted above.

According to still other embodiments, the first foam layer 404 may include a particular content of flame retardant filler component 420. For example, the first foam layer 404 may include a flame retardant filler component content of at least about 1 wt. % for a total weight of the first foam layer 404, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the first foam layer 404 may include a flame retardant filler component content of not greater than about 35 wt. % for a total weight of the first foam layer 404, such as, not greater than about 34 wt. % or not greater than about 33 wt. % or not greater than about 32 wt. % or not greater than about 31 wt. % or not greater than about 30 wt. % or not greater than about 28 wt. % or not greater than about 25 wt. % or not greater than about 23 wt. % or not great than about 20 wt. %. It will be appreciated that the flame retardant filler component content of the first foam layer 404 may be within a range between any of the values noted above. It will be further appreciated that the flame retardant filler component content of the first foam layer 404 may be any value between any of the minimum and maximum values noted above.

According to still other embodiments, the first foam layer 404 may include a particular content of insulation filler component 420. For example, the first foam layer 404 may include an insulation filler component content of at least about 1 wt. % for a total weight of the first foam layer 404, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the first foam layer 404 may include an insulation filler component content of not greater than about 25 wt. % for a total weight of the first foam layer 404, such as, not greater than about 24 wt. % or not greater than about 23 wt. % or not greater than about 22 wt. % or not greater than about 21 wt. % or not greater than about 20 wt. % or not greater than about 19 wt. % or not greater than about 18 wt. % or not greater than about 17 wt. % or not great than about 16 wt. %. It will be appreciated that the insulation filler component content of the first foam layer 404 may be within a range between any of the values noted above. It will be further appreciated that the insulation filler component content of the first foam layer 404 may be any value between any of the minimum and maximum values noted above.

According to certain embodiments, the layer 404 may have a particular flammability rating as measured according to ASTM D4986. In particular, the foam layer may have a HBF flammability rating as measured according to ASTM D4986.

According to certain embodiments, the first foam layer 404 may have a particular flammability rating as measured according to ASTM D3801. In particular, the foam layer may have a V-0 flammability rating as measured according to ASTM D3801.

According to certain embodiments, the thermal barrier composite 400 may have a particular flammability rating as measured according to ASTM D4986. In particular, the foam layer may have a HBF flammability rating as measured according to ASTM D4986.

According to certain embodiments, the thermal barrier composite 400 may have a particular flammability rating as measured according to ASTM D3801. In particular, the foam layer may have a V-0 flammability rating as measured according to ASTM D3801.

According to yet other embodiments, the first foam layer 404 may have a particular self-ignition time when exposed to a hot plate test at a temperature of 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the first foam layer 404 may have a self-ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self-ignition time of the first foam layer 404 may be within a range between any of the values noted above. It will be further appreciated that the self-ignition time of the first foam layer 404 may be any value between any of the values noted above.

According to yet other embodiments, the thermal barrier composite 400 may have a particular self-ignition time when exposed to a hot plate test at a temperature of 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the thermal barrier composite 400 may have a self-ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self-ignition time of the thermal barrier composite 400 may be within a range between any of the values noted above. It will be further appreciated that the self-ignition time of the thermal barrier composite 400 may be any value between any of the values noted above.

According to still other embodiments, the first foam layer 404 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the first foam layer 404 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the first foam layer 404 may have a cold side temperature of at least about 25° C. It will be appreciated that the cold side temperature of the first foam layer 404 may be within a range between any of the values noted above. It will be further appreciated that the cold side temperature of the first foam layer 404 may be any value between any of the values noted above.

According to still other embodiments, the thermal barrier composite 400 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the thermal barrier composite 400 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the thermal barrier composite 400 may have a cold side temperature of at least about 25° C. It will be appreciated that the cold side temperature of the thermal barrier composite 400 may be within a range between any of the values noted above. It will be further appreciated that the cold side temperature of the thermal barrier composite 400 may be any value between any of the values noted above.

According to still other embodiments, the thermal barrier composite 400 may have a particular burn-through time as measured when exposed to a torch test carried out at a temperature of 1000° C. For purposes of embodiments described herein, the torch test is carried out by preparing a 1 inch by 1 inch specimen of the material, which is placed 1.5 inches from a torch. The thermal couple is fixed on the flame side to measure the “hot side” temperature, which is adjusted to 1000° C. A second thermal couple is positioned to the opposite side of the sample to measure the “cold side” temperature. The time is measured until, if it occurs, the torch burns through the sample. According to particular embodiments, the thermal barrier composite 400 may have a burn-through time of at least about 6 minutes, such as, at least about 6.5 minutes or at least about 7 minutes or at least about 7.5 minutes or at least about 8 minutes or at least about 8.5 minutes or at least about 9.0 minutes or at least about 9.5 minutes or even at least about 10.0 minutes. It will be appreciated that the burn-through time of the thermal barrier composite 400 may be within a range between any of the values noted above. It will be further appreciated that the burn-through time of the thermal barrier composite 400 may be any value between any of the values noted above.

According to yet other embodiments, the first foam layer 404 may have a particular thickness. For example, the first foam layer 404 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the first foam layer 404 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the first foam layer 404 may be within a range between any of the minimum and maximum values noted above. It will be further appreciated that the thickness of the first foam layer 404 may be any value between any of the minimum and maximum values noted above.

According to yet other embodiments, the thermal barrier composite 400 may have a particular thickness. For example, the thermal barrier composite 400 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the thermal barrier composite 400 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the thermal barrier composite 400 may be within a range between any of the minimum and maximum values noted above. It will be further appreciated that the thickness of the thermal barrier composite 400 may be any value between any of the minimum and maximum values noted above.

According to yet other embodiments, the first foam layer 404 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the first foam layer 404 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the first foam layer 404 may have a 25% strain compression rating of at least about 5 kPa, such as, at least about 10 kPa or at least about 15 kPa or at least about 20 kPa or at least about 25 kPa. It will be appreciated that the 25% strain compression rating of the first foam layer 404 may be within a range between any of the minimum and maximum values noted above. It will be further appreciated that the 50% strain compression rating of the first foam layer 404 may be any value between any of the minimum and maximum values noted above.

According to yet other embodiments, the thermal barrier composite 400 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the thermal barrier composite 400 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the thermal barrier composite 400 may have a 25% strain compression rating of at least about 5 kPa, such as, at least about 10 kPa or at least about 15 kPa or at least about 20 kPa or at least about 25 kPa. It will be appreciated that the 25% strain compression rating of the thermal barrier composite 400 may be within a range between any of the minimum and maximum values noted above. It will be further appreciated that the 50% strain compression rating of the thermal barrier composite 400 may be any value between any of the minimum and maximum values noted above.

According to yet other embodiments, the first foam layer 404 may have a particular density. For purpose of embodiments described herein, the density of the first foam layer 404 may be determined according to ASTM D1056. According to certain embodiments, the first foam layer 404 may have a density of not greater than about 1200 kg/m³, such as, not great than about 1175 kg/m³ or not greater than about 1150 kg/m³ or not greater than about 1125 kg/m³ or not greater than about 1100 kg/m³ or not greater than about 1050 kg/m³ or not greater than about 1000 kg/m³ or not greater than about 950 kg/m³ or not greater than about 900 kg/m³ or not greater than about 850 kg/m³ or not greater than about 800 kg/m³ or not greater than about 750 kg/m³ or not greater than about 700 kg/m³ or even not greater than about 650 kg/m³. According to yet other embodiments, the first foam layer 404 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the first foam layer 404 may be within a range between any of the minimum and maximum values noted above. It will be further appreciated that the density of the first foam layer 404 may be any value between any of the minimum and maximum values noted above.

According to yet other embodiments, the thermal barrier composite 400 may have a particular density. For the purpose of embodiments described herein, the density of the first foam layer 404 may be determined according to ASTM D1056. According to certain embodiments, the thermal barrier composite 400 may have a density of not greater than about 1500 kg/m³, such as, not great than about 1475 kg/m′ or not greater than about 1450 kg/m′ or not greater than about 1425 kg/m³ or not greater than about 1400 kg/m³ or not greater than about 1350 kg/m³ or not greater than about 1300 kg/m³ or not greater than about 1250 kg/m³ or not greater than about 1200 kg/m³ or not greater than about 1150 kg/m³ or not greater than about 1100 kg/m³ or not greater than about 1050 kg/m³ or not greater than about 1000 kg/m³ or even not greater than about 950 kg/m³. According to yet other embodiments, the thermal barrier composite 400 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the thermal barrier composite 400 may be within a range between any of the minimum and maximum values noted above. It will be further appreciated that the density of the thermal barrier composite 400 may be any value between any of the minimum and maximum values noted above.

According to yet other embodiments, the first foam layer 404 may have a particular thermal conductivity as measured according to ASTM C518. For example, the first foam layer 404 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the first foam layer 404 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the first foam layer 404 may be within a range between any of the minimum and maximum values noted above. It will be further appreciated that the thermal conductivity of the first foam layer 404 may be any value between any of the minimum and maximum values noted above.

According to yet other embodiments, the thermal barrier composite 400 may have a particular thermal conductivity as measured according to ASTM C518. For example, the thermal barrier composite 400 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the thermal barrier composite 400 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the thermal barrier composite 400 may be within a range between any of the minimum and maximum values noted above. It will be further appreciated that the thermal conductivity of the thermal barrier composite 400 may be any value between any of the minimum and maximum values noted above.

According to still other embodiments, the first barrier layer 402 may be a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof.

According to still other embodiments, the first barrier layer 402 may include a particular material. For example, the first barrier layer 402 may include mica. According to still other embodiments, the first barrier layer 402 may include a mica-fiber glass fabric. According to yet other embodiments, the first barrier layer 402 may include a glass fabric. According to other embodiments, the first barrier layer 402 may include a silica fabric. According to still other embodiments, the first barrier layer 402 may include a basalt fabric. According to yet other embodiments, the first barrier layer 402 may include a vermiculite coated glass fabric. According to other embodiments, the first barrier layer 402 may include an aerogel. According to yet other embodiments, the first barrier layer 402 may include a non-woven glass fabric. According to still other embodiments, the first barrier layer 402 may include any combination of mica, a mica-fiber glass fabric, a glass fabric, a silica fabric, a basalt fabric, a vermiculite coated glass fabric, an aerogel, or a non-woven glass fabric. According to yet other embodiments, the first barrier layer 402 may include any lamination of mica, a mica-fiber glass fabric, a glass fabric, a silica fabric, a basalt fabric, a vermiculite coated glass fabric, an aerogel, or a non-woven glass fabric.

According to still other embodiments, the first barrier layer 402 may consist of a particular material. For example, the first barrier layer 402 may consist of mica. According to still other embodiments, the first barrier layer 402 may consist of a mica-fiber glass fabric. According to yet other embodiments, the first barrier layer 402 may consist of a glass fabric. According to other embodiments, the first barrier layer 402 may consist of a silica fabric. According to still other embodiments, the first barrier layer 402 may consist of a basalt fabric. According to yet other embodiments, the first barrier layer 402 may consist of a vermiculite coated glass fabric. According to other embodiments, the first barrier layer 402 may consist of an aerogel. According to yet other embodiments, the first barrier layer 402 may consist of a non-woven glass fabric. According to still other embodiments, the first barrier layer 402 may consist of any combination of mica, a mica-fiber glass fabric, a glass fabric, a silica fabric, a basalt fabric, a vermiculite coated glass fabric, an aerogel, or a non-woven glass fabric. According to yet other embodiments, the first barrier layer 402 may consist of any lamination of mica, a mica-fiber glass fabric, a glass fabric, a silica fabric, a basalt fabric, a vermiculite coated glass fabric, an aerogel, or a non-woven glass fabric.

According to still other embodiments, the first barrier layer 402 may be a particular material layer. For example, the first barrier layer 402 may be a mica layer. According to still other embodiments, the first barrier layer 402 may be a mica-fiber glass fabric layer. According to yet other embodiments, the first barrier layer 402 may be a glass fabric layer. According to other embodiments, the first barrier layer 402 may be a silica fabric layer. According to still other embodiments, the first barrier layer 402 may be a basalt fabric layer. According to yet other embodiments, the first barrier layer 402 may be a vermiculite coated glass fabric layer. According to other embodiments, the first barrier layer 402 may be an aerogel layer. According to yet other embodiments, the first barrier layer 402 may be a non-woven glass fabric layer. According to still other embodiments, the first barrier layer 402 may be a layer of any combination of mica, a mica-fiber glass fabric, a glass fabric, a silica fabric, a basalt fabric, a vermiculite coated glass fabric, an aerogel, or a non-woven glass fabric. According to yet other embodiments, the first barrier layer 402 may be a layer of any lamination of mica, a mica-fiber glass fabric, a glass fabric, a silica fabric, a basalt fabric, a vermiculite coated glass fabric, an aerogel, or a non-woven glass fabric.

According to yet other embodiments, the first barrier layer 402 may have a particular thickness. For example, the first barrier layer 402 may have a thickness of at least about 0.05 mm, such as, at least about 0.1 mm or at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.1 mm or at least about 1.2 mm or at least about 1.3 mm or even at least about 1.4 mm. According to still other embodiments, the first barrier layer 402 may have a thickness of not greater than about 7 mm, such as, not greater than about 6.5 mm or not greater than about 6.0 mm or not greater than about 5.5 mm or not greater than about 5.0 mm or not greater than about 4.5 mm or not greater than about 4.0 mm or no not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or even not greater than about 2.2 mm. It will be appreciated that the thickness of the first barrier layer 402 may be within a range between any of the minimum and maximum values noted above. It will be further appreciated that the thickness of the first barrier layer 402 may be any value between any of the minimum and maximum values noted above.

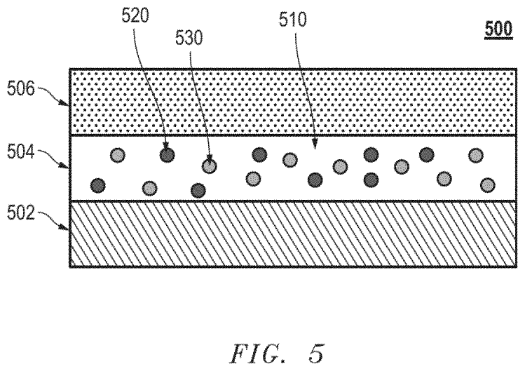

FIG. 5 shows another thermal barrier composite 500 according to embodiments described herein. As shown in FIG. 5, the thermal barrier composite 500 may include a first barrier layer 502, a first foam layer 504, and a second barrier layer 506. The first foam layer 504 may include a silicone-based matrix component 510, a flame retardant filler component 520, and an insulation filler component 530.

It will be appreciated that the thermal barrier composite 500 and all components described in reference to the thermal barrier composite 500 as shown in FIG. 5 may have any of the characteristics described herein with reference to corresponding components in FIG. 4. In particular, the characteristics of the thermal barrier composite 500, the first barrier layer 502, the first foam layer 504, the silicone-based matrix component 510, the flame retardant filler component 520, and the insulation filler component 530 shown in FIG. 5 may have any of the corresponding characteristics described herein in reference to thermal barrier composite 400, the first barrier layer 402, the first foam layer 404, the silicone-based matrix component 410, the flame retardant filler component 420, and the insulation filler component 430 shown in FIG. 4, respectively.

According to still other embodiments, the second barrier layer 506 may be a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof.

According to still other embodiments, the second barrier layer 506 may include a particular material. For example, the second barrier layer 506 may include mica. According to still other embodiments, the second barrier layer 506 may include a mica-fiber glass fabric. According to yet other embodiments, the second barrier layer 506 may include a glass fabric. According to other embodiments, the second barrier layer 506 may include a silica fabric. According to still other embodiments, the second barrier layer 506 may include a basalt fabric. According to yet other embodiments, the second barrier layer 506 may include a vermiculite coated glass fabric. According to other embodiments, the second barrier layer 506 may include an aerogel. According to yet other embodiments, the second barrier layer 506 may include a non-woven glass fabric. According to still other embodiments, the second barrier layer 506 may include any combination of mica, a mica-fiber glass fabric, a glass fabric, a silica fabric, a basalt fabric, a vermiculite coated glass fabric, an aerogel, or a non-woven glass fabric. According to yet other embodiments, the second barrier layer 506 may include any lamination of mica, a mica-fiber glass fabric, a glass fabric, a silica fabric, a basalt fabric, a vermiculite coated glass fabric, an aerogel, or a non-woven glass fabric.

According to still other embodiments, the second barrier layer 506 may consist of a particular material. For example, the second barrier layer 506 may consist of mica. According to still other embodiments, the second barrier layer 506 may consist of a mica-fiber glass fabric. According to yet other embodiments, the second barrier layer 506 may consist of a glass fabric. According to other embodiments, the second barrier layer 506 may consist of a silica fabric. According to still other embodiments, the second barrier layer 506 may consist of a basalt fabric. According to yet other embodiments, the second barrier layer 506 may consist of a vermiculite coated glass fabric. According to other embodiments, the second barrier layer 506 may consist of an aerogel. According to yet other embodiments, the second barrier layer 506 may consists of a non-woven glass fabric. According to still other embodiments, the second barrier layer 506 may consist of any combination of mica, a mica-fiber glass fabric, a glass fabric, a silica fabric, a basalt fabric, a vermiculite coated glass fabric, an aerogel, or a non-woven glass fabric. According to yet other embodiments, the second barrier layer 506 may consist of any lamination of mica, a mica-fiber glass fabric, a glass fabric, a silica fabric, a basalt fabric, a vermiculite coated glass fabric, an aerogel, or a non-woven glass fabric.

According to still other embodiments, the second barrier layer 506 may be a particular material layer. For example, the second barrier layer 506 may be a mica layer. According to still other embodiments, the second barrier layer 506 may be a mica-fiber glass fabric layer. According to yet other embodiments, the second barrier layer 506 may be a glass fabric layer. According to other embodiments, the second barrier layer 506 may be a silica fabric layer. According to still other embodiments, the second barrier layer 506 may be a basalt fabric layer. According to yet other embodiments, the second barrier layer 506 may be a vermiculite coated glass fabric layer. According to other embodiments, the second barrier layer 506 may be an aerogel layer. According to yet other embodiments, the second barrier layer 506 may be a non-woven glass fabric layer. According to still other embodiments, the second barrier layer 506 may be a layer of any combination of mica, a mica-fiber glass fabric, a glass fabric, a silica fabric, a basalt fabric, a vermiculite coated glass fabric, an aerogel, or a non-woven glass fabric. According to yet other embodiments, the second barrier layer 506 may be a layer of any lamination of mica, a mica-fiber glass fabric, a glass fabric, a silica fabric, a basalt fabric, a vermiculite coated glass fabric, an aerogel, or a non-woven glass fabric.

According to yet other embodiments, the second barrier layer 506 may have a particular thickness. For example, the second barrier layer 506 may have a thickness of at least about 0.05 mm, such as, at least about 0.1 mm or at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.1 mm or at least about 1.2 mm or at least about 1.3 mm or even at least about 1.4 mm. According to still other embodiments, the second barrier layer 506 may have a thickness of not greater than about 3 7 mm, such as, not greater than about 6.5 mm or not greater than about 6.0 mm or not greater than about 5.5 mm or not greater than about 5.0 mm or not greater than about 4.5 mm or not greater than about 4.0 mm or no not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or even not greater than about 2.2 mm. It will be appreciated that the thickness of the second barrier layer 506 may be within a range between any of the minimum and maximum values noted above. It will be further appreciated that the thickness of the second barrier layer 506 may be any value between any of the minimum and maximum values noted above.

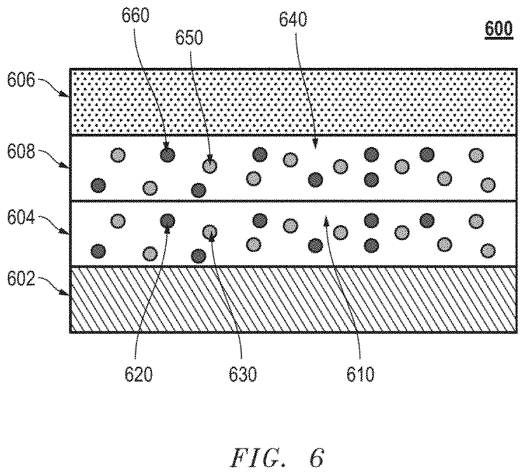

FIG. 6 shows another thermal barrier composite 600 according to embodiments described herein. As shown in FIG. 6, the thermal barrier composite 600 may include a first barrier layer 602, a first foam layer 604, a second foam layer 608, and a second barrier layer 606. The first foam layer 604 may include a silicone-based matrix component 610, a flame retardant filler component 620, and an insulation filler component 630. The second foam layer 608 may include a silicone-based matrix component 640, a flame retardant filler component 650, and an insulation filler component 660. As shown in FIG. 6, the first foam layer 604 and the second foam layer 608 are both between the first barrier layer 602 and the second barrier layer 608.

It will be appreciated that the thermal barrier composite 600 and all components described in reference to the thermal barrier composite 600 as shown in FIG. 6 may have any of the characteristics described herein with reference to corresponding components in FIG. 5 and/or FIG. 4. In particular, the characteristics of the thermal barrier composite 600, the first barrier layer 602, the first foam layer 604, the second barrier layer 606, the silicone-based matrix component 610, the flame retardant filler component 620, and the insulation filler component 630 shown in FIG. 6 may have any of the corresponding characteristics described herein in reference to thermal barrier composite 400 (500), the first barrier layer 402 (502), the first foam layer 404 (504), the silicone-based matrix component 410 (510), the flame retardant filler component 420 (520), and the insulation filler component 430 (530) shown in FIG. 4 (FIG. 5), respectively.

According to particular embodiments, the silicone-based matrix component 640 of the second foam layer 608 may include platinum catalyzed addition cured silicone foam. According to still other embodiments, the silicone-based matrix component 640 may include peroxide cured silicone foam. According to yet other embodiments, the silicone-based matrix component 640 may include tin catalyzed silicone foam. According to still other embodiments, the silicone-based matrix component 640 may include any combination of a platinum catalyzed addition cured silicone foam, a peroxide cured silicone foam, and a tin catalyzed silicone foam.

According to particular embodiments, the silicone-based matrix component 640 may consist of platinum catalyzed addition cured silicone foam. According to still other embodiments, the silicone-based matrix component 640 may consist of peroxide cured silicone foam. According to yet other embodiments, the silicone-based matrix component 640 may consist of tin catalyzed silicone foam. According to still other embodiments, the silicone-based matrix component 640 may consist of any combination of a platinum catalyzed addition cured silicone foam, a peroxide cured silicone foam, and a tin catalyzed silicone foam.

According to particular embodiments, the silicone-based matrix component 640 may be a platinum catalyzed addition cured silicone foam layer. According to still other embodiments, the silicone-based matrix component 640 may be a peroxide cured silicone foam layer. According to yet other embodiments, the silicone-based matrix component 640 may be a tin catalyzed silicone foam layer. According to still other embodiments, the silicone-based matrix component 640 may be a layer of any combination of a platinum catalyzed addition cured silicone foam, a peroxide cured silicone foam, and a tin catalyzed silicone foam.

According to yet other embodiments, the flame retardant filler component 650 may be selected from a particular group of materials. For example, the flame retardant filler component 650 may be selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

According to still other embodiments, the flame retardant filler component 650 may include a particular material. For example, the flame retardant filler component 650 may include metal hydrates. According to still other embodiments, the flame retardant filler component 650 may include borate compounds. According to still other embodiments, the flame retardant filler component 650 may include platinum compounds. According to still other embodiments, the flame retardant filler component 650 may include transition metal oxides. According to other embodiments, the flame retardant filler component 650 may include metal carbonates. According to still other embodiments, the flame retardant filler component 650 may include calcium silicates. According to yet other embodiments, the flame retardant filler component 650 may include aluminum silicates. According to yet other embodiments, the flame retardant filler component 650 may include magnesium silicates. According to still other embodiments, the flame retardant filler component 650 may include glass frits. According to still other embodiments, the flame retardant filler component 650 may include alkaline salts. According to yet other embodiments, the flame retardant filler component 650 may include vermiculites. According to still other embodiments, the flame retardant filler component 650 may include any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 650 may consist of a particular material. For example, the flame retardant filler component 650 may consist of metal hydrates. According to still other embodiments, the flame retardant filler component 650 may consist of borate compounds. According to still other embodiments, the flame retardant filler component 650 may consist of platinum compounds. According to still other embodiments, the flame retardant filler component 650 may consist of transition metal oxides. According to other embodiments, the flame retardant filler component 650 may consist of metal carbonates. According to still other embodiments, the flame retardant filler component 650 may consist of calcium silicates. According to yet other embodiments, the flame retardant filler component 650 may consist of aluminum silicates. According to yet other embodiments, the flame retardant filler component 650 may consist of magnesium silicates. According to still other embodiments, the flame retardant filler component 650 may consist of glass frits. According to still other embodiments, the flame retardant filler component 650 may consist of alkaline salts. According to yet other embodiments, the flame retardant filler component 650 may consist of vermiculites. According to still other embodiments, the flame retardant filler component 650 may consist of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 650 may be a particular material. For example, the flame retardant filler component 650 may be a metal hydrate filler. According to still other embodiments, the flame retardant filler component 650 may be a borate salt filler. According to still other embodiments, the flame retardant filler component 650 may be a platinum compound filler. According to still other embodiments, the flame retardant filler component 650 may be a transition metal oxide filler. According to other embodiments, the flame retardant filler component 650 may be a metal carbonate filler. According to still other embodiments, the flame retardant filler component 650 may be a calcium silicate filler. According to yet other embodiments, the flame retardant filler component 650 may be an aluminum silicate filler. According to yet other embodiments, the flame retardant filler component 650 may be a magnesium silicate filler. According to still other embodiments, the flame retardant filler component 650 may be a glass frit filler. According to still other embodiments, the flame retardant filler component 650 may be an alkaline salt filler. According to yet other embodiments, the flame retardant filler component 650 may be a vermiculite filler. According to still other embodiments, the flame retardant filler component 650 may be a filler of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 650 may be selected from a particular group of metal hydrate materials. For example, the flame retardant filler component 650 may be selected from a group consisting of aluminum trihydrate, magnesium dihydroxides, boehmite, calcium hydroxide, Huntite, gypsum, hydromagnesite, and any combination thereof.

According to still other embodiments, the flame retardant filler component 650 may include a particular metal hydrate material. For example, the flame retardant filler component 650 may include aluminum trihydrate. According to still other embodiments, the flame retardant filler component 650 may include magnesium dihydroxides. According to yet other embodiments, the flame retardant filler component 650 may include boehmite. According to other embodiments, the flame retardant filler component 650 may include calcium hydroxide. According to still other embodiments, the flame retardant filler component 650 may include Huntite. According to yet other embodiments, the flame retardant filler component 650 may include gypsum. According to other embodiments, the flame retardant filler component 650 may include hydromagnesite. According to still other embodiments, the flame retardant filler component 650 may include any combination of aluminum trihydrate, magnesium dihydroxides, boehmite, calcium hydroxide, Huntite, gypsum, or hydromagnesite.

According to still other embodiments, the flame retardant filler component 650 may consist of a particular metal hydrate material. For example, the flame retardant filler component 650 may consist of aluminum trihydrate. According to still other embodiments, the flame retardant filler component 650 may consist of magnesium dihydroxides. According to yet other embodiments, the flame retardant filler component 650 may consist of boehmite. According to other embodiments, the flame retardant filler component 650 may consist of calcium hydroxide. According to still other embodiments, the flame retardant filler component 650 may consist of Huntite. According to yet other embodiments, the flame retardant filler component 650 may consist of gypsum. According to other embodiments, the flame retardant filler component 650 may consist of hydromagnesite. According to still other embodiments, the flame retardant filler component 650 may consist of any combination of aluminum trihydrate, magnesium dihydroxides, boehmite, calcium hydroxide, Huntite, gypsum, or hydromagnesite.

According to still other embodiments, the flame retardant filler component 650 may be a particular metal hydrate material filler. For example, the flame retardant filler component 650 may be an aluminum trihydrate filler. According to still other embodiments, the flame retardant filler component 650 may be a magnesium dihydroxide filler. According to yet other embodiments, the flame retardant filler component 650 may be a boehmite filler. According to other embodiments, the flame retardant filler component 650 may be a calcium hydroxide filler. According to still other embodiments, the flame retardant filler component 650 may be a Huntite filler. According to yet other embodiments, the flame retardant filler component 650 may be a gypsum filler. According to other embodiments, the flame retardant filler component 650 may be a hydromagnesite filler. According to still other embodiments, the flame retardant filler component 650 may be a filler of any combination of aluminum trihydrate, magnesium dihydroxides, boehmite, calcium hydroxide, Huntite, gypsum, or hydromagnesite.

According to still other embodiments, the flame retardant filler component 650 may be selected from a particular group of borate salt materials. For example, the flame retardant filler component 650 may be selected from a group consisting of zinc borate, calcium borate, sodium borate, potassium borate, lithium borate, and any combination thereof.

According to still other embodiments, the flame retardant filler component 650 may include a particular borate salt material. For example, the flame retardant filler component 650 may include zinc borate. According to yet other embodiments, the flame retardant filler component 650 may include calcium borate. According to other embodiments, the flame retardant filler component 650 may include sodium borate. According to still other embodiments, the flame retardant filler component 650 may include potassium borate. According to yet other embodiments, the flame retardant filler component 650 may include lithium borate. According to still other embodiments, the flame retardant filler component 650 may include any combination of zinc borate, calcium borate, sodium borate, potassium borate, or lithium borate.

According to still other embodiments, the flame retardant filler component 650 may consist of a particular borate salt material. For example, the flame retardant filler component 650 may consist of zinc borate. According to yet other embodiments, the flame retardant filler component 650 may consist of calcium borate. According to other embodiments, the flame retardant filler component 650 may consist of sodium borate. According to still other embodiments, the flame retardant filler component 650 may consist of potassium borate. According to yet other embodiments, the flame retardant filler component 650 may consist of lithium borate. According to still other embodiments, the flame retardant filler component 650 may consist of any combination of zinc borate, calcium borate, sodium borate, potassium borate, or lithium borate.

According to still other embodiments, the flame retardant filler component 650 may be a particular borate salt material filler. For example, the flame retardant filler component 650 may be a zinc borate filler. According to yet other embodiments, the flame retardant filler component 650 may be a calcium borate filler. According to other embodiments, the flame retardant filler component 650 may be a sodium borate filler. According to still other embodiments, the flame retardant filler component 650 may be a potassium borate filler. According to yet other embodiments, the flame retardant filler component 650 may be a lithium borate filler. According to still other embodiments, the flame retardant filler component 650 may be a filler of any combination of zinc borate, calcium borate, sodium borate, potassium borate, or lithium borate.

According to still other embodiments, the flame retardant filler component 650 may be selected from a particular group of platinum compound materials. For example, the flame retardant filler component 650 may be selected from a group consisting of platinum-1,3-divinyl-1,1,3,3-tetramethyldisiloxane, hexachloroplatinic acid, and any combination thereof.

According to still other embodiments, the flame retardant filler component 650 may include a particular of platinum compound material. For example, the flame retardant filler component 650 may include platinum-1,3-divinyl-1,1,3,3-tetramethyldisiloxane. According to yet other embodiments, the flame retardant filler component 650 may include hexachloroplatinic acid. According to still other embodiments, the flame retardant filler component 650 may include any combination of platinum-1,3-divinyl-1,1,3,3-tetramethyldisiloxane, and hexachloroplatinic acid.

According to still other embodiments, the flame retardant filler component 650 may consist of a particular of platinum compound material. For example, the flame retardant filler component 650 may consist of platinum-1,3-divinyl-1,1,3,3-tetramethyldisiloxane. According to yet other embodiments, the flame retardant filler component 650 may consist of hexachloroplatinic acid. According to still other embodiments, the flame retardant filler component 650 may consist of any combination of platinum-1,3-divinyl-1,1,3,3-tetramethyldisiloxane, and hexachloroplatinic acid.

According to still other embodiments, the flame retardant filler component 650 may be a particular platinum compound material filler. For example, the flame retardant filler component 650 may be a platinum-1,3-divinyl-1,1,3,3-tetramethyldisiloxane filler. According to yet other embodiments, the flame retardant filler component 650 may be a hexachloroplatinic acid filler. According to still other embodiments, the flame retardant filler component 650 may be a filler or any combination of platinum-1,3-divinyl-1,1,3,3-tetramethyldisiloxane, and hexachloroplatinic acid.

According to still other embodiments, the flame retardant filler component 650 may be selected from a particular group of transition metal oxide materials. For example, the flame retardant filler component 650 may be selected from a group consisting of iron oxide, cerium oxide, titanium oxide, zinc oxide, and any combination thereof.

According to still other embodiments, the flame retardant filler component 650 may include a particular transition metal oxide material. For example, the flame retardant filler component 650 may include iron oxide. According to yet other embodiments, the flame retardant filler component 650 may include cerium oxide. According to other embodiments, the flame retardant filler component 650 may include zinc oxide. According to still other embodiments, the flame retardant filler component 650 may include any combination of iron oxide, cerium oxide, titanium oxide, or zinc oxide.

According to still other embodiments, the flame retardant filler component 650 may consist of a particular transition metal oxide material. For example, the flame retardant filler component 650 may consist of iron oxide. According to yet other embodiments, the flame retardant filler component 650 may consist of cerium oxide. According to other embodiments, the flame retardant filler component 650 may consist of zinc oxide. According to still other embodiments, the flame retardant filler component 650 may consist of any combination of iron oxide, cerium oxide, titanium oxide, or zinc oxide.

According to still other embodiments, the flame retardant filler component 650 may be a particular transition metal oxide material filler. For example, the flame retardant filler component 650 may be an iron oxide filler. According to yet other embodiments, the flame retardant filler component 650 may be a cerium oxide filler. According to other embodiments, the flame retardant filler component 650 may be a zinc oxide filler. According to still other embodiments, the flame retardant filler component 650 may be a filler of any combination of iron oxide, cerium oxide, titanium oxide, or zinc oxide.

According to still other embodiments, the flame retardant filler component 650 may be selected from a particular group of metal carbonate materials. For example, the flame retardant filler component 650 may be selected from a group consisting of Huntite, calcium carbonate, and any combination thereof.

According to still other embodiments, the flame retardant filler component 650 may include a particular transition metal carbonate material. For example, the flame retardant filler component 650 may include Huntite. According to yet other embodiments, the flame retardant filler component 650 may include calcium carbonate. According to still other embodiments, the flame retardant filler component 650 may include any combination of Huntite, or calcium carbonate.

According to still other embodiments, the flame retardant filler component 650 may consist of a particular transition metal carbonate material. For example, the flame retardant filler component 650 may consist of Huntite. According to yet other embodiments, the flame retardant filler component 650 may consist of calcium carbonate. According to still other embodiments, the flame retardant filler component 650 may consist of any combination of Huntite, or calcium carbonate.

According to still other embodiments, the flame retardant filler component 650 may be a particular transition metal carbonate material filler. For example, the flame retardant filler component 650 may be a Huntite filler. According to yet other embodiments, the flame retardant filler component 650 may be a calcium carbonate filler. According to still other embodiments, the flame retardant filler component 650 may be a filler of any combination of Huntite, or calcium carbonate.

According to still other embodiments, the flame retardant filler component 650 may be selected from a particular group of metal carbonate mixtures. For example, the flame retardant filler component 650 may be selected from a group consisting of a natural mixture of hydromagnesite and Huntite, synthetic magnesium carbonate hydroxide pentahydrate, and any combination thereof.

According to still other embodiments, the flame retardant filler component 650 may include a particular metal carbonate mixtures. For example, the flame retardant filler component 650 may include a natural mixture of hydromagnesite. According to other embodiments, the flame retardant filler component 650 may include a natural mixture of hydromagnesite. According to still other embodiments, the flame retardant filler component 650 may include any combination of a natural mixture of hydromagnesite and Huntite, or synthetic magnesium carbonate hydroxide pentahydrate.

According to still other embodiments, the flame retardant filler component 650 may consist of a particular metal carbonate mixtures. For example, the flame retardant filler component 650 may consist of a natural mixture of hydromagnesite. According to other embodiments, the flame retardant filler component 650 may consist of a natural mixture of hydromagnesite. According to still other embodiments, the flame retardant filler component 650 may consist of any combination of a natural mixture of hydromagnesite and Huntite, or synthetic magnesium carbonate hydroxide pentahydrate.

According to still other embodiments, the flame retardant filler component 650 may be a particular metal carbonate mixture filler. For example, the flame retardant filler component 650 may be a natural mixture of hydromagnesite. According to other embodiments, the flame retardant filler component 650 may be a filler of a natural mixture of hydromagnesite. According to still other embodiments, the flame retardant filler component 650 may be a filler of any combination of a natural mixture of hydromagnesite and Huntite, or synthetic magnesium carbonate hydroxide pentahydrate.

According to still other embodiments, the flame retardant filler component 650 may be selected from a particular group of alumina silicate materials or magnesium silicate materials. For example, the flame retardant filler component 650 may be selected from a group consisting of wallastonite, mica, clay, kaolin, talc, vermiculite, and any combination thereof.

According to still other embodiments, the flame retardant filler component 650 may include a particular alumina silicate material or magnesium silicate material. For example, the flame retardant filler component 650 may include wallastonite. According to yet other embodiments, the flame retardant filler component 650 may include mica. According to still other embodiments, the flame retardant filler component 650 may include clay. According to other embodiments, the flame retardant filler component 650 may include kaolin. According to yet other embodiments, the flame retardant filler component 650 may include a talc. According to other embodiments, the flame retardant filler component 650 may include vermiculite. According to still other embodiments, the flame retardant filler component 650 may include any combination of wallastonite, mica, clay, kaolin, talc, or vermiculite.

According to still other embodiments, the flame retardant filler component 650 may consist of a particular alumina silicate material or magnesium silicate material. For example, the flame retardant filler component 650 may consist of wallastonite. According to yet other embodiments, the flame retardant filler component 650 may consist of mica. According to still other embodiments, the flame retardant filler component 650 may consist of clay. According to other embodiments, the flame retardant filler component 650 may consist of kaolin. According to yet other embodiments, the flame retardant filler component 650 may consist of talc. According to other embodiments, the flame retardant filler component 650 may consist of vermiculite. According to still other embodiments, the flame retardant filler component 650 may consist of any combination of wallastonite, mica, clay, kaolin, talc, or vermiculite.

According to still other embodiments, the flame retardant filler component 650 may be a filler of a particular alumina silicate material or magnesium silicate material. For example, the flame retardant filler component 650 may be a wallastonite filler. According to yet other embodiments, the flame retardant filler component 650 may be a mica filler. According to still other embodiments, the flame retardant filler component 650 may be a clay filler. According to other embodiments, the flame retardant filler component 650 may be a kaolin filler. According to yet other embodiments, the flame retardant filler component 650 may be a talc filler. According to other embodiments, the flame retardant filler component 650 may be a vermiculite filler. According to still other embodiments, the flame retardant filler component 650 may be a filler of any combination of wallastonite, mica, clay, kaolin, talc, or vermiculite.

According to still other embodiments, the flame retardant filler component 650 may be selected from a particular group of alkaline salt materials. For example, the flame retardant filler component 650 may be selected from a group consisting of sodium carbonate, potassium carbonate, and any combination thereof.

According to still other embodiments, the flame retardant filler component 650 may include a particular alkaline salt material. For example, the flame retardant filler component 650 may include sodium carbonate. According to yet other embodiments, the flame retardant filler component 650 may include potassium carbonate. According to still other embodiments, the flame retardant filler component 650 may include any combination of sodium carbonate, or potassium carbonate.

According to still other embodiments, the flame retardant filler component 650 may consist of a particular alkaline salt material. For example, the flame retardant filler component 650 may consist of sodium carbonate. According to yet other embodiments, the flame retardant filler component 650 may consist of potassium carbonate. According to still other embodiments, the flame retardant filler component 650 may consist of any combination of sodium carbonate, or potassium carbonate.

According to still other embodiments, the flame retardant filler component 650 may be a particular alkaline salt material filler. For example, the flame retardant filler component 650 may be a sodium carbonate filler. According to yet other embodiments, the flame retardant filler component 650 may be a potassium carbonate filler. According to still other embodiments, the flame retardant filler component 650 may be a filler of any combination of sodium carbonate, or potassium carbonate.

According to still other embodiments, the insulation filler component 660 may be selected from a particular group of materials. For example, the insulation filler component 660 may be selected from a group consisting of expanded perlite, unexpanded perlite, glass beads, vermiculite, expanded vermiculite, expanded glass, zeolite, aerogel, silica, porous silica, porous alumina, and any combination thereof.

According to still other embodiments, the insulation filler component 660 may include a particular material. For example, the insulation filler component 660 may include expanded perlite. According to yet other embodiments, the insulation filler component 660 may include unexpanded perlite. According to yet other embodiments, the insulation filler component 660 may include glass beads. According to yet other embodiments, the insulation filler component 660 may include vermiculite. According to yet other embodiments, the insulation filler component 660 may include expanded vermiculite. According to yet other embodiments, the insulation filler component 660 may include expanded glass. According to yet other embodiments, the insulation filler component 660 may include zeolite. According to still other embodiments, the insulation filler component 660 may include aerogel. According to yet other embodiments, the insulation filler component 660 may include silica. According to yet other embodiments, the insulation filler component 660 may include porous silica. According to other embodiments, the insulation filler component 660 may include porous alumina. According to still other embodiments, the insulation filler component 660 may include any combination of expanded perlite, unexpanded perlite, glass beads, vermiculite, expanded vermiculite, expanded glass, zeolite, aerogel, silica, porous silica, or porous alumina.

According to still other embodiments, the insulation filler component 660 may consist of a particular material. For example, the insulation filler component 660 may consist of expanded perlite. According to yet other embodiments, the insulation filler component 660 may consist of unexpanded perlite. According to yet other embodiments, the insulation filler component 660 may consist of glass beads. According to yet other embodiments, the insulation filler component 660 may consist of vermiculite. According to yet other embodiments, the insulation filler component 660 may consist of expanded vermiculite. According to yet other embodiments, the insulation filler component 660 may consist of expanded glass. According to yet other embodiments, the insulation filler component 660 may consist of zeolite. According to still other embodiments, the insulation filler component 660 may consist of aerogel. According to yet other embodiments, the insulation filler component 660 may consist of silica. According to yet other embodiments, the insulation filler component 660 may consist of porous silica. According to other embodiments, the insulation filler component 660 may consist of porous alumina. According to still other embodiments, the insulation filler component 660 may consist of any combination of expanded perlite, unexpanded perlite, glass beads, vermiculite, expanded vermiculite, expanded glass, zeolite, aerogel, silica, porous silica, or porous alumina.

According to still other embodiments, the insulation filler component 660 may be a filler of a particular material. For example, the insulation filler component 660 may be an expanded perlite filler. According to yet other embodiments, the insulation filler component 660 may be an unexpanded perlite filler. According to yet other embodiments, the insulation filler component 660 may be a glass beads filler. According to yet other embodiments, the insulation filler component 660 may be a vermiculite filler. According to yet other embodiments, the insulation filler component 660 may be an expanded vermiculite filler. According to yet other embodiments, the insulation filler component 660 may be an expanded glass filler. According to yet other embodiments, the flame retardant filler component 220 may be a zeolite filler. According to still other embodiments, the insulation filler component 660 may be an aerogel filler. According to yet other embodiments, the insulation filler component 660 may be a silica filler. According to yet other embodiments, the insulation filler component 660 may be a porous silica filler. According to other embodiments, the insulation filler component 660 may be a porous alumina filler. According to still other embodiments, the insulation filler component 660 may be a filler of any combination of expanded perlite, unexpanded perlite, glass beads, vermiculite, expanded vermiculite, expanded glass, zeolite, aerogel, silica, porous silica, or porous alumina.

According to certain embodiments, the second foam layer 608 may include a particular content of the silicone-based matrix component 640. For example, the second foam layer 608 may include a silicone-based matrix component content of at least about 20 wt. % for a total weight of the second foam layer 608, such as, at least about 25 wt. % or at least about 30 wt. % or at least about 35 wt. % or at least about 40 wt. % or at least about 45 wt. % or even at least about 50 wt. %. According to yet other embodiments, the second foam layer 608 may include a silicone-based matrix component content of not greater than about 85 wt. % for a total weight of the second foam layer 608, such as, not greater than about 80 wt. % or not greater than about 75 wt. % or not greater than about 70 wt. % or even not greater than about 65 wt. %. It will be appreciated that the silicone-based matrix component content of the second foam layer 608 may be within a range between any of the values noted above. It will be further appreciated that the silicone-based matrix component content of the second foam layer 608 may be any value between any of the minimum and maximum values noted above.

According to still other embodiments, the second foam layer 608 may include a particular content of flame retardant filler component 650. For example, the second foam layer 608 may include a flame retardant filler component content of at least about 1 wt. % for a total weight of the second foam layer 608, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the second foam layer 608 may include a flame retardant filler component content of not greater than about 35 wt. % for a total weight of the second foam layer 608, such as, not greater than about 34 wt. % or not greater than about 33 wt. % or not greater than about 32 wt. % or not greater than about 31 wt. % or not greater than about 30 wt. % or not greater than about 28 wt. % or not greater than about 25 wt. % or not greater than about 23 wt. % or not great than about 20 wt. %. It will be appreciated that the flame retardant filler component content of the second foam layer 608 may be within a range between any of the values noted above. It will be further appreciated that the flame retardant filler component content of the second foam layer 608 may be any value between any of the minimum and maximum values noted above.

According to still other embodiments, the second foam layer 608 may include a particular content of insulation filler component 650. For example, the second foam layer 608 may include an insulation filler component content of at least about 1 wt. % for a total weight of the second foam layer 608, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the second foam layer 608 may include an insulation filler component content of not greater than about 25 wt. % for a total weight of the second foam layer 608, such as, not greater than about 24 wt. % or not greater than about 23 wt. % or not greater than about 22 wt. % or not greater than about 21 wt. % or not greater than about 20 wt. % or not greater than about 19 wt. % or not greater than about 18 wt. % or not greater than about 17 wt. % or not great than about 16 wt. %. It will be appreciated that the insulation filler component content of the second foam layer 608 may be within a range between any of the values noted above. It will be further appreciated that the insulation filler component content of the second foam layer 608 may be any value between any of the minimum and maximum values noted above.

According to certain embodiments, the second foam layer 608 may have a particular flammability rating as measured according to ASTM D4986. In particular, the foam layer may have a HBF flammability rating as measured according to ASTM D4986.

According to certain embodiments, the second foam layer 608 may have a particular flammability rating as measured according to ASTM D3801. In particular, the foam layer may have a V-0 flammability rating as measured according to ASTM D3801.

According to yet other embodiments, the second foam layer 608 may have a particular self-ignition time when exposed to a hot plate test at a temperature of 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the second foam layer 608 may have a self-ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self-ignition time of the second foam layer 608 may be within a range between any of the values noted above. It will be further appreciated that the self-ignition time of the second foam layer 608 may be any value between any of the values noted above.

According to still other embodiments, the second foam layer 608 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the second foam layer 608 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the second foam layer 608 may have a cold side temperature of at least about 25° C. It will be appreciated that the cold side temperature of the second foam layer 608 may be within a range between any of the values noted above. It will be further appreciated that the cold side temperature of the second foam layer 608 may be any value between any of the values noted above.

According to yet other embodiments, the second foam layer 608 may have a particular thickness. For example, the second foam layer 608 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the second foam layer 608 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the second foam layer 608 may be within a range between any of the minimum and maximum values noted above. It will be further appreciated that the thickness of the second foam layer 608 may be any value between any of the minimum and maximum values noted above.

According to yet other embodiments, the second foam layer 608 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the second foam layer 608 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the second foam layer 608 may have a 25% strain compression rating of at least about 5 kPa, such as, at least about 10 kPa or at least about 15 kPa or at least about 20 kPa or at least about 25 kPa. It will be appreciated that the 25% strain compression rating of the second foam layer 608 may be within a range between any of the minimum and maximum values noted above. It will be further appreciated that the 50% strain compression rating of the second foam layer 608 may be any value between any of the minimum and maximum values noted above.

According to yet other embodiments, the second foam layer 608 may have a particular density. For the purpose of embodiments described herein, the density of the second foam layer 608 may be determined according to ASTM D1056. According to certain embodiments, the second foam layer 608 may have a density of not greater than about 1200 kg/m³, such as, not great than about 1175 kg/m′ or not greater than about 1150 kg/m′ or not greater than about 1125 kg/m³ or not greater than about 1100 kg/m³ or not greater than about 1050 kg/m³ or not greater than about 1000 kg/m³ or not greater than about 950 kg/m³ or not greater than about 900 kg/m³ or not greater than about 850 kg/m³ or not greater than about 800 kg/m³ or not greater than about 750 kg/m³ or not greater than about 700 kg/m³ or even not greater than about 650 kg/m³. According to yet other embodiments, the second foam layer 608 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the second foam layer 608 may be within a range between any of the minimum and maximum values noted above. It will be further appreciated that the density of the second foam layer 608 may be any value between any of the minimum and maximum values noted above.

According to yet other embodiments, the second foam layer 608 may have a particular thermal conductivity as measured according to ASTM C518. For example, the second foam layer 608 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the second foam layer 608 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK or not greater than about 0.09 W/mK or not greater than about 0.08 W/mK or even not greater than about 0.07 W/mK. It will be appreciated that the thermal conductivity of the second foam layer 608 may be within a range between any of the minimum and maximum values noted above. It will be further appreciated that the thermal conductivity of the second foam layer 608 may be any value between any of the minimum and maximum values noted above.

According to certain embodiments, the thermal barrier composite described herein may be formed according to any acceptable forming process for a thermal barrier composite. According to a particular embodiment, the thermal barrier composite may be formed using a lamination process where the porous foam and barrier layer are laminated using a transfer adhesive such as, for example, a silicon adhesive, a rubber adhesive, an acrylic adhesive, a phenolic adhesive, a polyurethane-based adhesive or any combination thereof. According to still other embodiments, the thermal barrier composite may be formed using a lamination process with a porous foam and a coated barrier layer, where the coating on the barrier layer is an adhesive, such as, a silicon adhesive, a rubber adhesive, an acrylic adhesive, a phenolic adhesive, a polyurethane-based adhesive or any combination thereof. According to still other embodiments, the thermal barrier composite may be formed using a direct cast forming process, wherein the foam is directly cast onto the barrier films or between the barrier films.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A multilayer composite comprising: a first barrier layer, and a first foam layer comprising a silicone-based matrix component, a flame retardant filler component and an insulation filler component, wherein the multilayer composite comprises a thickness of at least about 0.5 mm to and no greater than about 10 mm, and wherein the multilayer composite comprises a HBF flammability rating as measured according to ASTM D4986.

Embodiment 2. A multilayer composite comprising: a first barrier layer, and a first foam layer comprising a silicone-based matrix component, a flame retardant filler component and an insulation filler component, wherein the multilayer composite comprises a thickness of at least about 0.5 mm to and no greater than about 10 mm, and wherein the multilayer composite comprises a self-ignition time of at least about 1 min when exposed to a hotplate test at 650° C.

Embodiment 3. A multilayer composite comprising: a first barrier layer, and a first foam layer comprising a silicone based matrix component, a flame retardant filler component and an insulation filler component, wherein the first barrier layer comprises a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof, wherein the flame retardant filler component comprises a filler selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof, wherein the insulation filler component comprises a filler selected from the group consisting of expanded perlite, unexpanded perlite, glass beads, vermiculite, expanded vermiculite, expanded glass, zeolite, aerogel, silica, porous silica, porous alumina, and any combination thereof, and wherein the multilayer composite comprises a thickness of at least about 0.5 mm to and no greater than about 10 mm.

Embodiment 4. The multilayer composite of any one of embodiments 1, 2, and 3, wherein the silicone-based matrix component of the first foam layer comprises platinum catalyzed addition cured silicone foam, peroxide cured silicone foam, tin catalyzed silicone foam, and any combination thereof.

Embodiment 5. The multilayer composite of any one of embodiments 1, 2, and 3, wherein the flame retardant filler component of the first foam layer comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

Embodiment 6. The multilayer composite of any one of embodiments 1, 2, and 3, wherein the flame retardant filler component of the first foam layer comprises a filler selected from a group consisting of aluminum trihydrate, magnesium dihydroxides, Boehmite, calcium hydroxide, Huntite, gypsum, hydromagnesite, and any combination thereof.

Embodiment 7. The multilayer composite of any one of embodiments 1, 2, and 3, wherein the flame retardant filler component of the first foam layer comprises a filler selected from a group consisting of zinc borate, calcium borate, sodium borate, potassium borate, lithium borate, and any combination thereof.

Embodiment 8. The multilayer composite of any one of embodiments 1, 2, and 3, wherein the flame retardant filler component of the first foam layer comprises a filler selected from a group consisting of platinum-1,3-divinyl-1,1,3,3-tetramethyldisiloxane, hexachloroplatinic acid, and any combination thereof.

Embodiment 9. The multilayer composite of any one of embodiments 1, 2, and 3, wherein the flame retardant filler component of the first foam layer comprises a filler selected from a group consisting of iron oxide, cerium oxide, titanium oxide, zinc oxide, and any combination thereof.

Embodiment 10. The multilayer composite of any one of embodiments 1, 2, and 3, wherein the flame retardant filler of the first foam layer component comprises a filler selected from a group consisting of Huntite, calcium carbonate, and any combination thereof.

Embodiment 11. The multilayer composite of any one of embodiments 1, 2, and 3, wherein the flame retardant filler component of the first foam layer comprises a filler selected from a group consisting of a natural mixture of hydromagnesite and Huntite, synthetic magnesium carbonate hydroxide pentahydrate, and any combination thereof.

Embodiment 12. The multilayer composite of any one of embodiments 1, 2, and 3, wherein the flame retardant filler component of the first foam layer comprises a filler selected from a group consisting of wallastonite, mica, clay, kaolin, talc, vermiculite, and any combination thereof.

Embodiment 13. The multilayer composite of any one of embodiments 1, 2, and 3, wherein the flame retardant filler component of the first foam layer comprises a filler selected from a group consisting of sodium carbonate, potassium carbonate, and any combination thereof.

Embodiment 14. The multilayer composite of any one of embodiments 1, 2, and 3, wherein the insulation filler component of the first foam layer comprises a filler selected from the group consisting of expanded perlite, unexpanded perlite, glass beads, vermiculite, expanded vermiculite, expanded glass, zeolite, aerogel, silica, porous silica, porous alumina, and any combination thereof.

Embodiment 15. The multilayer composite of any one of embodiments 1, 2, and 3, wherein the first foam layer comprises a silicone-based matrix component content of at least about 20 wt. % for a total weight of the first foam layer.

Embodiment 16. The multilayer composite of any one of embodiments 1, 2, and 3, wherein the first foam layer comprises a silicone-based matrix component content of not greater than about 85 wt. % for a total weight of the first foam layer.

Embodiment 17. The multilayer composite of any one of embodiments 1, 2, and 3, wherein the first foam layer comprises a flame retardant filler component content of at least about 1 wt. % for a total weight of the first foam layer.

Embodiment 18. The multilayer composite of any one of embodiments 1, 2, and 3, wherein the first foam layer comprises a flame retardant filler component of not greater than about 35 wt. % for a total weight of the first foam layer.

Embodiment 19. The multilayer composite of any one of embodiments 1, 2, and 3, wherein the first foam layer comprises an insulation filler component of not greater than about 25 wt. % for a total weight of the first foam layer.

Embodiment 20. The multilayer composite of any one of embodiments 1, 2, and 3, wherein the first foam layer comprises an insulation filler component content of at least about 1 wt. % for a total weight of the first foam layer.

Embodiment 21. The multilayer composite of any one of embodiments 1, 2, and 3, wherein the first foam layer comprises a HBF flammability rating as measured according to ASTM D4986.

Embodiment 22. The multilayer composite of any one of embodiments 1, 2, and 3, wherein the multilayer composite comprises a V-0 flammability rating as measured according to ASTM D3801.

Embodiment 23. The multilayer composite of any one of embodiments 1, 2, and 3, wherein the first foam layer comprises a self-ignition time of at least about 1 minute when exposed to a hotplate test at 650° C.

Embodiment 24. The multilayer composite of any one of embodiments 1, 2, and 3, wherein the multilayer comprises a self-ignition time of at least about 1 minute when exposed to a hotplate test at 650° C.

Embodiment 25. The multilayer composite of any one of embodiments 1, 2, and 3, wherein the multilayer composite comprises a burn-through time of at least about 6 minutes when exposed to a torch test at 1000° C.

Embodiment 26. The multilayer composite of any one of embodiments 1, 2, and 3, wherein the first foam layer comprises a cold side temperature of not greater than about 300° C. as measured at 5 minutes when a 3 mm foam is exposed to a hotplate test at 650° C.

Embodiment 27. The multilayer composite of any one of embodiments 1, 2, and 3, wherein the first foam layer comprises a cold side temperature of at least about 25° C. as measured at 5 minutes when exposed to a hotplate test at 650° C.

Embodiment 28. The multilayer composite of any one of embodiments 1, 2, and 3, wherein the multilayer composite comprises a cold side temperature of not greater than about 300° C. as measured at 5 minutes when a 3 mm foam is exposed to a hotplate test at 650° C.

Embodiment 29. The multilayer composite of any one of embodiments 1, 2, and 3, wherein the multilayer composite comprises a cold side temperature of at least about 25° C. as measured at 5 minutes when exposed to a hotplate test at 650° C.

Embodiment 30. The multilayer composite of any one of embodiments 1, 2, and 3, wherein the first foam layer comprises a thickness of at least about 0.5 mm.

Embodiment 31. The multilayer composite of any one of embodiments 1, 2, and 3, wherein the first foam layer comprises a thickness of not greater than about 10 mm.

Embodiment 32. The multilayer composite of any one of embodiments 1, 2, and 3, wherein the multilayer composite comprises a thickness of at least about 0.5 mm.

Embodiment 33. The multilayer composite of any one of embodiments 1, 2, and 3, wherein the multilayer composite comprises a thickness of not greater than about 10 mm.

Embodiment 34. The multilayer composite of any one of embodiments 1, 2, and 3, wherein the first foam layer comprises a 25% strain compression rating of at least about 5 kPa.

Embodiment 35. The multilayer composite of any one of embodiments 1, 2, and 3, wherein the first foam layer comprises a 25% strain compression rating of not greater than about 500 kPa.

Embodiment 36. The multilayer composite of any one of embodiments 1, 2, and 3, wherein the multilayer composite comprises a 25% strain compression rating of at least about 5 kPa.

Embodiment 37. The multilayer composite of any one of embodiments 1, 2, and 3, wherein the multilayer composite comprises a 25% strain compression rating of not greater than about 500 kPa.

Embodiment 38. The multilayer composite of any one of embodiments 1, 2, and 3, wherein the first foam layer comprises a density of not greater than about 1200 kg/m³.

Embodiment 39. The multilayer composite of any one of embodiments 1, 2, and 3, wherein the first foam layer comprises a density of at least about 100 kg/m³.

Embodiment 40. The multilayer composite of any one of embodiments 1, 2, and 3, wherein the multilayer composite layer comprises a density of not greater than about 1500 kg/m³.

Embodiment 41. The multilayer composite of any one of embodiments 1, 2, and 3, wherein the multilayer composite comprises a density of at least about 100 kg/m³.

Embodiment 42. The multilayer composite of any one of embodiments 1, 2, and 3, wherein the first foam layer comprises a thermal conductivity of at least about 0.01 W/mK.

Embodiment 43. The multilayer composite of any one of embodiments 1, 2, and 3, wherein the first foam layer comprises a thermal conductivity of not greater than about 0.15 W/mK.

Embodiment 44. The multilayer composite of any one of embodiments 1, 2, and 3, wherein the multilayer composite comprises a thermal conductivity of at least about 0.01 W/mK.

Embodiment 45. The multilayer composite of any one of embodiments 1, 2, and 3, wherein the multilayer composite comprises a thermal conductivity of not greater than about 0.15 W/mK.

Embodiment 46. The multilayer composite of any one of embodiments 1, 2, and 3, wherein the first barrier layer comprises a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof.

Embodiment 47. The multilayer composite of any one of embodiments 1, 2, and 3, wherein the first barrier layer has a thickness of at least about 0.05 mm.

Embodiment 48. The multilayer composite of any one of embodiments 1, 2, and 3, wherein the first barrier layer has a thickness of not greater than about 7 mm.

Embodiment 49. The multilayer composite of any one of embodiments 1, 2, and 3, wherein the multilayer composite further comprises a second barrier layer and wherein the first foam layer is between the first barrier layer and the second barrier layer.

Embodiment 50. The multilayer composite of embodiment 49, wherein the second barrier layer comprises a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof.

Embodiment 51. The multilayer composite of embodiment 49, wherein the second barrier layer has a thickness of at least about 0.05 mm.

Embodiment 52. The multilayer composite of embodiment 49, wherein the second barrier layer has a thickness of not greater than about 7 mm.

Embodiment 53. The multilayer composite of any one of embodiments 1, 2, and 3, wherein the multilayer composite further comprises a second foam layer and a second barrier layer, and wherein the first foam layer and the second foam layer are both between the first barrier layer and the second barrier layer.

Embodiment 54. The multilayer composite of embodiment 53, wherein the second barrier layer comprises a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof.

Embodiment 55. The multilayer composite of embodiment 53, wherein the second barrier layer has a thickness of at least about 0.05 mm.

Embodiment 56. The multilayer composite of embodiment 53, wherein the second barrier layer has a thickness of not greater than about 7 mm.

Embodiment 57. The multilayer composite of embodiment 53, wherein the silicone-based matrix component of the second foam layer comprises platinum catalyzed addition cured silicone foam, peroxide cured silicone foam, tin catalyzed silicone foam, and any combination thereof.

Embodiment 58. The multilayer composite of embodiment 53, wherein the flame retardant filler component of the second foam layer comprises a filler selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

Embodiment 59. The multilayer composite of embodiment 53, wherein the flame retardant filler component of the second foam layer comprises a filler selected from the group consisting of aluminum trihydrate, magnesium dihydroxides, Boehmite, calcium hydroxide, Huntite, gypsum, hydromagnesite, and any combination thereof.

Embodiment 60. The multilayer composite of embodiment 53, wherein the flame retardant filler component of the second foam layer comprises a filler selected from the group consisting of zinc borate, calcium borate, sodium borate, potassium borate, lithium borate, and any combination thereof.

Embodiment 61. The multilayer composite of embodiment 53, wherein the flame retardant filler component of the second foam layer comprises a filler selected from the group consisting of platinum-1,3-divinyl-1,1,3,3-tetramethyldisiloxane, hexachloroplatinic acid, and any combination thereof.

Embodiment 62. The multilayer composite of embodiment 53, wherein the flame retardant filler component of the second foam layer comprises a filler selected from the group consisting of iron oxide, cerium oxide, titanium oxide, zinc oxide, and any combination thereof.

Embodiment 63. The multilayer composite of embodiment 53, wherein the flame retardant filler component of the second foam layer comprises a filler selected from the group consisting of Huntite, calcium carbonate, and any combination thereof.

Embodiment 64. The multilayer composite of embodiment 53, wherein the flame retardant filler component of the second foam layer comprises a filler selected from the group consisting of a natural mixture of hydromagnesite and Huntite, synthetic magnesium carbonate hydroxide pentahydrate, and any combination thereof.

Embodiment 65. The multilayer composite of embodiment 53, wherein the flame retardant filler component of the second foam layer comprises a filler selected from the group consisting of wallastonite, mica, clay, kaolin, talc, vermiculite, and any combination thereof.

Embodiment 66. The multilayer composite of embodiment 53, wherein the flame retardant filler component of the second foam layer comprises a filler selected from the group consisting of sodium carbonate, potassium carbonate, and any combination thereof.

Embodiment 67. The multilayer composite of embodiment 53, the insulation filler component of the second foam layer comprises a filler selected from the group consisting of expanded perlite, unexpanded perlite, glass beads, vermiculite, expanded vermiculite, expanded glass, zeolite, aerogel, silica, porous silica, porous alumina, and any combination thereof.

Embodiment 68. The multilayer composite of embodiment 53, wherein the second foam layer comprises a silicone-based matrix component content of at least about 20 wt. % for a total weight of the second foam layer.

Embodiment 69. The multilayer composite of embodiment 53, wherein the second foam layer comprises a silicone-based matrix component content of not greater than about 85 wt. % for a total weight of the second foam layer.

Embodiment 70. The multilayer composite of embodiment 53, wherein the second foam layer comprises a flame retardant filler component content of at least about 1 wt. % for a total weight of the second foam layer.

Embodiment 71. The multilayer composite of embodiment 53, wherein the second foam layer comprises a flame retardant filler component of not greater than about 25 wt. % for a total weight of the second foam layer.

Embodiment 72. The multilayer composite of embodiment 53, wherein the second foam layer comprises an insulation filler component of not greater than about 25 wt. % for a total weight of the second foam layer.

Embodiment 73. The multilayer composite of embodiment 53, wherein the second foam layer comprises a insulation filler component content of at least about 1 wt. % for a total weight of the second foam layer.

Embodiment 74. The multilayer composite of embodiment 53, wherein the second foam layer comprises a HBF flammability rating as measured according to ASTM D4986.

Embodiment 75. The multilayer composite of embodiment 53, wherein the second foam layer comprises a self-ignition time of at least about 1 minute when exposed to a hotplate test at 650° C.

Embodiment 76. The multilayer composite of embodiment 53, wherein the second foam layer comprises a cold side temperature of not greater than about 300° C. as measured at 5 minutes when exposed to a hotplate test at 650° C.

Embodiment 77. The multilayer composite of embodiment 53, wherein the second foam layer comprises a thickness of at least about 0.05 mm.

Embodiment 78. The multilayer composite of embodiment 53, wherein the second foam layer comprises a thickness of not greater than about 10 mm.

Embodiment 79. The multilayer composite of embodiment 53, wherein the second foam layer comprises a 25% strain compression rating of at least about 5 kPa.

Embodiment 80. The multilayer composite of embodiment 53, wherein the second foam layer comprises a 25% strain compression rating of not greater than about 500 kPa.

Embodiment 81. The multilayer composite of embodiment 53, wherein the second foam layer comprises a density of not greater than about 1200 kg/m³.

Embodiment 82. The multilayer composite of embodiment 53, wherein the second foam layer comprises wherein the foam layer comprises a density of at least about 100 kg/m³.

Embodiment 83. The multilayer composite of embodiment 53, wherein the second foam layer comprises a thermal conductivity of at least about 0.01 W/mK.

Embodiment 84. The multilayer composite of embodiment 53, wherein the second foam layer comprises a thermal conductivity of not greater than about 0.15 W/mK.

Embodiment 85. A thermal barrier composite comprising: a first barrier layer, and a first foam layer comprising a silicone-based matrix component, a flame retardant filler component and an insulation filler component, wherein the thermal barrier composite comprises a thickness of at least about 0.5 mm to and no greater than about 10 mm, and wherein the thermal barrier composite comprises a HBF flammability rating as measured according to ASTM D4986.

Embodiment 86. A thermal barrier composite comprising: a first barrier layer, and a first foam layer comprising a silicone-based matrix component, a flame retardant filler component and an insulation filler component, wherein the thermal barrier composite comprises a thickness of at least about 0.5 mm to and no greater than about 10 mm, and wherein the thermal barrier composite comprises a self-ignition time of at least about 1 min when exposed to a hotplate test at 650° C.

Embodiment 87. A thermal barrier composite comprising: a first barrier layer, and a first foam layer comprising a silicone based matrix component, a flame retardant filler component and an insulation filler component, wherein the first barrier layer comprises a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof, wherein the flame retardant filler component comprises a filler selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof, wherein the insulation filler component comprises a filler selected from the group consisting of expanded perlite, unexpanded perlite, glass beads, vermiculite, expanded vermiculite, expanded glass, zeolite, aerogel, silica, porous silica, porous alumina, and any combination thereof, and wherein the thermal barrier composite comprises a thickness of at least about 0.5 mm to and no greater than about 10 mm.

Embodiment 88. The thermal barrier composite of any one of embodiments 85, 86, and 87, wherein the silicone-based matrix component comprises platinum catalyzed addition cured silicone foam, peroxide cured silicone foam, tin catalyzed silicone foam, and any combination thereof.

Embodiment 89. The thermal barrier composite of any one of embodiments 85, 86, and 87, wherein the flame retardant filler component comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

Embodiment 90. The thermal barrier composite of any one of embodiments 85, 86, and 87, wherein the flame retardant filler component comprises a filler selected from a group consisting of aluminum trihydrate, magnesium dihydroxides, Boehmite, calcium hydroxide, Huntite, gypsum, hydromagnesite, and any combination thereof.

Embodiment 91. The thermal barrier composite of any one of embodiments 85, 86, and 87, wherein the flame retardant filler component comprises a filler selected from a group consisting of zinc borate, calcium borate, sodium borate, potassium borate, lithium borate, and any combination thereof.

Embodiment 92. The thermal barrier composite of any one of embodiments 85, 86, and 87, wherein the flame retardant filler component comprises a filler selected from a group consisting of platinum-1,3-divinyl-1,1,3,3-tetramethyldisiloxane, hexachloroplatinic acid, and any combination thereof.

Embodiment 93. The thermal barrier composite of any one of embodiments 85, 86, and 87, wherein the flame retardant filler component comprises a filler selected from a group consisting of iron oxide, cerium oxide, titanium oxide, zinc oxide, and any combination thereof.

Embodiment 94. The thermal barrier composite of any one of embodiments 85, 86, and 87, wherein the flame retardant filler component comprises a filler selected from a group consisting of Huntite, calcium carbonate, and any combination thereof.

Embodiment 95. The thermal barrier composite of any one of embodiments 85, 86, and 87, wherein the flame retardant filler component comprises a filler selected from a group consisting of a natural mixture of hydromagnesite and Huntite, synthetic magnesium carbonate hydroxide pentahydrate, and any combination thereof.

Embodiment 96. The thermal barrier composite of any one of embodiments 85, 86, and 87, wherein the flame retardant filler component comprises a filler selected from a group consisting of wallastonite, mica, clay, kaolin, talc, vermiculite, and any combination thereof.

Embodiment 97. The thermal barrier composite of any one of embodiments 85, 86, and 87, wherein the flame retardant filler component comprises a filler selected from a group consisting of sodium carbonate, potassium carbonate, and any combination thereof.

Embodiment 98. The thermal barrier composite of any one of embodiments 85, 86, and 87, wherein the insulation filler component comprises a filler selected from the group consisting of expanded perlite, unexpanded perlite, glass beads, vermiculite, expanded vermiculite, expanded glass, zeolite, aerogel, silica, porous silica, porous alumina, and any combination thereof.

Embodiment 99. The thermal barrier composite of any one of embodiments 85, 86, and 87, wherein the first foam layer comprises a silicone-based matrix component content of at least about 20 wt. % for a total weight of the first foam layer.

Embodiment 100. The thermal barrier composite of any one of embodiments 85, 86, and 87, wherein the first foam layer comprises a silicone-based matrix component content of not greater than about 85 wt. % for a total weight of the first foam layer.

Embodiment 101. The thermal barrier composite of any one of embodiments 85, 86, and 87, wherein the first foam layer comprises a flame retardant filler component content of at least about 1 wt. % for a total weight of the first foam layer.

Embodiment 102. The thermal barrier composite of any one of embodiments 85, 86, and 87, wherein the first foam layer comprises a flame retardant filler component of not greater than about 35 wt. % for a total weight of the first foam layer.

Embodiment 103. The thermal barrier composite of any one of embodiments 85, 86, and 87, wherein the first foam layer comprises an insulation filler component of not greater than about 25 wt. % for a total weight of the first foam layer.

Embodiment 104. The thermal barrier composite of any one of embodiments 85, 86, and 87, wherein the first foam layer comprises an insulation filler component content of at least about 1 wt. % for a total weight of the first foam layer.

Embodiment 105. The thermal barrier composite of any one of embodiments 85, 86, and 87, wherein the first foam layer comprises a HBF flammability rating as measured according to ASTM D4986.

Embodiment 106. The thermal barrier composite of any one of embodiments 85, 86, and 87, wherein the thermal barrier composite comprises a HBF flammability rating as measured according to ASTM D4986.

Embodiment 107. The thermal barrier composite of any one of embodiments 85, 86, and 87, wherein the first foam layer comprises a self-ignition time of at least about 1 minute when exposed to a hotplate test at 650° C.

Embodiment 108. The thermal barrier composite of any one of embodiments 85, 86, and 87, wherein the multilayer comprises a self-ignition time of at least about 1 minute when exposed to a hotplate test at 650° C.

Embodiment 109. The thermal barrier composite of any one of embodiments 85, 86, and 87, wherein the thermal barrier composite comprises a burn-through time of at least about 6 minutes when exposed to a torch test at 1000° C.

Embodiment 110. The thermal barrier composite of any one of embodiments 85, 86, and 87, wherein the first foam layer comprises a cold side temperature of not greater than about 300° C. as measured at 5 minutes when a 3 mm foam is exposed to a hotplate test at 650° C.

Embodiment 111. The thermal barrier composite of any one of embodiments 85, 86, and 87, wherein the first foam layer comprises a cold side temperature of at least about 25° C. as measured at 5 minutes when exposed to a hotplate test at 650° C.

Embodiment 112. The thermal barrier composite of any one of embodiments 85, 86, and 87, wherein the thermal barrier composite comprises a cold side temperature of not greater than about 300° C. as measured at 5 minutes when a 3 mm foam is exposed to a hotplate test at 650° C.

Embodiment 113. The thermal barrier composite of any one of embodiments 85, 86, and 87, wherein the thermal barrier composite comprises a cold side temperature of at least about 25° C. as measured at 5 minutes when exposed to a hotplate test at 650° C.

Embodiment 114. The thermal barrier composite of any one of embodiments 85, 86, and 87, wherein the first foam layer comprises a thickness of at least about 0.5 mm.

Embodiment 115. The thermal barrier composite of any one of embodiments 85, 86, and 87, wherein the first foam layer comprises a thickness of not greater than about 10 mm.

Embodiment 116. The thermal barrier composite of any one of embodiments 85, 86, and 87, wherein the thermal barrier composite comprises a thickness of at least about 0.5 mm.

Embodiment 117. The thermal barrier composite of any one of embodiments 85, 86, and 87, wherein the thermal barrier composite comprises a thickness of not greater than about 10 mm.

Embodiment 118. The thermal barrier composite of any one of embodiments 85, 86, and 87, wherein the first foam layer comprises a 25% strain compression rating of at least about 5 kPa.

Embodiment 119. The thermal barrier composite of any one of embodiments 85, 86, and 87, wherein the first foam layer comprises a 25% strain compression rating of not greater than about 500 kPa.

Embodiment 120. The thermal barrier composite of any one of embodiments 85, 86, and 87, wherein the thermal barrier composite comprises a 25% strain compression rating of at least about 5 kPa.

Embodiment 121. The thermal barrier composite of any one of embodiments 85, 86, and 87, wherein the thermal barrier composite comprises a 25% strain compression rating of not greater than about 500 kPa.

Embodiment 122. The thermal barrier composite of any one of embodiments 85, 86, and 87, wherein the first foam layer comprises a density of not greater than about 1200 kg/m³.

Embodiment 123. The thermal barrier composite of any one of embodiments 85, 86, and 87, wherein the first foam layer comprises a density of at least about 100 kg/m³.

Embodiment 124. The thermal barrier composite of any one of embodiments 85, 86, and 87, wherein the thermal barrier composite layer comprises a density of not greater than about 1500 kg/m³.

Embodiment 125. The thermal barrier composite of any one of embodiments 85, 86, and 87, wherein the thermal barrier composite comprises a density of at least about 100 kg/m³.

Embodiment 126. The thermal barrier composite of any one of embodiments 85, 86, and 87, wherein the first foam layer comprises a thermal conductivity of at least about 0.01 W/mK.

Embodiment 127. The thermal barrier composite of any one of embodiments 85, 86, and 87, wherein the first foam layer comprises a thermal conductivity of not greater than about 0.15 W/mK.

Embodiment 128. The thermal barrier composite of any one of embodiments 85, 86, and 87, wherein the thermal barrier composite comprises a thermal conductivity of at least about 0.01 W/mK.

Embodiment 129. The thermal barrier composite of any one of embodiments 85, 86, and 87, wherein the thermal barrier composite comprises a thermal conductivity of not greater than about 0.15 W/mK.

Embodiment 130. The thermal barrier composite of any one of embodiments 85, 86, and 87, wherein the first barrier layer comprises a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof.

Embodiment 131. The thermal barrier composite of any one of embodiments 85, 86, and 87, wherein the first barrier layer has a thickness of at least about 0.05 mm.

Embodiment 132. The thermal barrier composite of any one of embodiments 85, 86, and 87, wherein the first barrier layer has a thickness of not greater than about 7 mm.

Embodiment 133. The thermal barrier composite of any one of embodiments 85, 86, and 87, wherein the thermal barrier composite further comprises a second barrier layer and wherein the first foam layer is between the first barrier layer and the second barrier layer.

Embodiment 134. The thermal barrier composite of embodiment 133, wherein the second barrier layer comprises a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof.

Embodiment 135. The thermal barrier composite of embodiment 133, wherein the second barrier layer has a thickness of at least about 0.05 mm.

Embodiment 136. The thermal barrier composite of embodiment 133, wherein the second barrier layer has a thickness of not greater than about 7 mm.

Embodiment 137. The thermal barrier composite of any one of embodiments 85, 86, and 87, wherein the thermal barrier composite further comprises a second foam layer and a second barrier layer, and wherein the first foam layer and the second foam layer are both between the first barrier layer and the second barrier layer.

Embodiment 138. The thermal barrier composite of embodiment 137, wherein the second barrier layer comprises a material selected from the group consisting of mica, a mica-fiber glass fabric, a glass fabric, a silica fabric, a basalt fabric, a vermiculite coated glass fabric, an aerogel, a non-woven glass fabric, any combination thereof, and any laminate thereof.

Embodiment 139. The thermal barrier composite of embodiment 137, wherein the second barrier layer has a thickness of at least about 0.05 mm.

Embodiment 140. The thermal barrier composite of embodiment 137, wherein the second barrier layer has a thickness of not greater than about 7 mm.

Embodiment 141. The thermal barrier composite of embodiment 137, wherein the silicone based matrix component of the second foam layer comprises platinum catalyzed addition cured silicone foam, peroxide cured silicone foam, tin catalyzed silicone foam, and any combination thereof.

Embodiment 142. The thermal barrier composite of embodiment 137, wherein the flame retardant filler component of the second foam layer comprises a filler selected from the group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

Embodiment 143. The thermal barrier composite of embodiment 137, wherein the flame retardant filler component of the second foam layer comprises a filler selected from the group consisting of aluminum trihydrate, magnesium dihydroxides, Boehmite, calcium hydroxide, Huntite, gypsum, hydromagnesite, and any combination thereof.

Embodiment 144. The thermal barrier composite of embodiment 137, wherein the flame retardant filler component of the second foam layer comprises a filler selected from the group consisting of zinc borate, calcium borate, sodium borate, potassium borate, lithium borate, and any combination thereof.

Embodiment 145. The thermal barrier composite of embodiment 137, wherein the flame retardant filler component of the second foam layer comprises a filler selected from the group consisting of platinum-1,3-divinyl-1,1,3,3-tetramethyldisiloxane, hexachloroplatinic acid, and any combination thereof.

Embodiment 146. The thermal barrier composite of embodiment 137, wherein the flame retardant filler component of the second foam layer comprises a filler selected from the group consisting of iron oxide, cerium oxide, titanium oxide, zinc oxide, and any combination thereof.

Embodiment 147. The thermal barrier composite of embodiment 137, wherein the flame retardant filler component of the second foam layer comprises a filler selected from the group consisting of Huntite, calcium carbonate, and any combination thereof.

Embodiment 148. The thermal barrier composite of embodiment 137, wherein the flame retardant filler component of the second foam layer comprises a filler selected from the group consisting of a natural mixture of hydromagnesite and Huntite, synthetic magnesium carbonate hydroxide pentahydrate, and any combination thereof.

Embodiment 149. The thermal barrier composite of embodiment 137, wherein the flame retardant filler component of the second foam layer comprises a filler selected from the group consisting of wallastonite, mica, clay, kaolin, talc, vermiculite, and any combination thereof.

Embodiment 150. The thermal barrier composite of embodiment 137, wherein the flame retardant filler component of the second foam layer comprises a filler selected from the group consisting of sodium carbonate, potassium carbonate, and any combination thereof.

Embodiment 151. The thermal barrier composite of embodiment 137, the insulation filler component of the second foam layer comprises a filler selected from the group consisting of expanded perlite, unexpanded perlite, glass beads, vermiculite, expanded vermiculite, expanded glass, zeolite, aerogel, silica, porous silica, porous alumina, and any combination thereof.

Embodiment 152. The thermal barrier composite of embodiment 137, wherein the second foam layer comprises a silicone-based matrix component content of at least about 20 wt. % for a total weight of the second foam layer.

Embodiment 153. The thermal barrier composite of embodiment 137, wherein the second foam layer comprises a silicone-based matrix component content of not greater than about 85 wt. % for a total weight of the second foam layer.

Embodiment 154. The thermal barrier composite of embodiment 137, wherein the second foam layer comprises a flame retardant filler component content of at least about 1 wt. % for a total weight of the second foam layer.

Embodiment 155. The thermal barrier composite of embodiment 137, wherein the second foam layer comprises a flame retardant filler component of not greater than about 25 wt. % for a total weight of the second foam layer.

Embodiment 156. The thermal barrier composite of embodiment 137, wherein the second foam layer comprises an insulation filler component of not greater than about 25 wt. % for a total weight of the second foam layer.

Embodiment 157. The thermal barrier composite of embodiment 137, wherein the second foam layer comprises an insulation filler component content of at least about 1 wt. % for a total weight of the second foam layer.

Embodiment 158. The thermal barrier composite of embodiment 137, wherein the second foam layer comprises a HBF flammability rating as measured according to ASTM D4986.

Embodiment 159. The thermal barrier composite of embodiment 137, wherein the second foam layer comprises a self-ignition time of at least about 1 minute when exposed to a hotplate test at 650° C.

Embodiment 160. The thermal barrier composite of embodiment 137, wherein the second foam layer comprises a cold side temperature of not greater than about 300° C. as measured at 5 minutes when exposed to a hotplate test at 650° C.

Embodiment 161. The thermal barrier composite of embodiment 137, wherein the second foam layer comprises a thickness of at least about 0.5 mm.

Embodiment 162. The thermal barrier composite of embodiment 137, wherein the second foam layer comprises a thickness of not greater than about 10 mm.

Embodiment 163. The thermal barrier composite of embodiment 137, wherein the second foam layer comprises a 25% strain compression rating of at least about 5 kPa.

Embodiment 164. The thermal barrier composite of embodiment 137, wherein the second foam layer comprises a 25% strain compression rating of not greater than about 500 kPa.

Embodiment 165. The thermal barrier composite of embodiment 137, wherein the second foam layer comprises a density of not greater than about 1200 kg/m³.

Embodiment 166. The thermal barrier composite of embodiment 137, wherein the second foam layer comprises wherein the foam layer comprises a density of at least about 100 kg/m³.

Embodiment 167. The thermal barrier composite of embodiment 137, wherein the second foam layer comprises a thermal conductivity of at least about 0.01 W/mK.

Embodiment 168. The thermal barrier composite of embodiment 137, wherein the second foam layer comprises a thermal conductivity of not greater than about 0.15 W/mK.

### EXAMPLES

The concepts described herein will be further described in the following Examples, which do not limit the scope of the invention described in the claims.

### Example 1

Six sample multilayer composites S1, S2, S3, S4, S5 and S6 were formed according to embodiments described herein. One comparative sample multilayer composite CS1 was formed for comparison to the sample multilayer composites S1-S6. The construction and composition of each multilayer composite S1-S6 and comparative sample multilayer composite CS1 are summarized in table 1 below.

TABLE 1
Multilayer Composite Construction/Composition

| | | | Foam Layer Composition | | | | |
|---|---|---|---|---|---|---|---|
| | | | (wt. % for a total weight of the foam layer) | | | | |
| | | | Silicone | | Flame Retardant | | |
| | Sample | | Based | Insulation | Filler Component | | |
| | Thickness | Barrier | Matrix | Filler | | Zinc | Calcium |
| Sample | (mm) | Layer | Component | Component | ATH | Borate | Borate |
| S1 | 3 | 0.1 mm | 80 | 0 | 10 | 10 | 0 |
| | | Mica | | | | | |
| S2 | 3.3 | 0.1 mm | 88 | 0 | 12 | 0 | 0 |
| | | Mica | | | | | |
| S3 | 2.7 | 0.1 mm | 73 | 18 | 9 | 0 | 0 |
| | | Mica | | | | | |
| S4 | 2.5 | 0.1 mm | 66 | 17 | 9 | 0 | 8 |
| | | Mica | | | | | |
| S5 | 2.2 | 0.2 mm | 66 | 17 | 9 | 8 | 0 |
| | | Mica | | | | | |
| S6 | 3.5 | 0.3 mm | 66 | 17 | 9 | 8 | 0 |
| | | S-glass | | | | | |
| CS1 | 2.6 | NONE | 66 | 17 | 9 | 8 | 0 |

The performance ratings (i.e. the flame resistance rating, self-ignition time, burn-through time, and cold-side temperature) of the sample multilayer composites S1-S6, and the comparative sample multilayer composite CS1 are summarized in Table 2 below. It will be appreciated that the flame resistance rating is based on the sample's performance in a UL94 VO test, the self-ignition time is measured in a 650° C. hot plate test as described herein, the burn-through time is measured in a 1000° C. torch test as described herein and the cold-side temperature is measured in a 650° C. hot plate test as described herein.

TABLE 2
Foam Layer Performance

| | | | | | | Cold-Side |
|---|---|---|---|---|---|---|
| | Flame | | Cold-Side | Burn- | | Temperature |
| | Resistance | Self-Ignition | Temperature at 5 | through Time | | at 6 min in |
| | Rating | Time in 650° C. | min in 650° C. | in 1000° C. | | 1000° C. |
| Sample | (UL94 V0 - Y/N) | Hot Plate Test | Hot Plate Test | Torch Test | | Torch Test |
| S1 | Y | — | — | >6 | min | 522° C. |
| S2 | Y | — | — | >6 | min | 730° C. |
| S3 | Y | — | — | >6 | min | 515° C. |
| S4 | Y | >5 min | — | >6 | min | 453° C. |
| S5 | Y | >5 min | 167° C. | >6 | min | 367° C. |
| S6 | Y | >5 min | 171° C. | >6 | min | 494° C. |
| CS1 | Y | >5 min | 226° C. | 90 | seconds | — |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A multilayer composite comprising:
a first barrier layer, and
a first foam layer comprising a silicone-based matrix component, a flame retardant filler component and an insulation filler component,
wherein the multilayer composite comprises a thickness of at least about 0.5 mm to and no greater than about 10 mm, and
wherein the multilayer composite comprises a HBF flammability rating as measured according to ASTM D4986.

2. The multilayer composite of claim 1, wherein the silicone-based matrix component of the first foam layer comprises platinum catalyzed addition cured silicone foam, peroxide cured silicone foam, tin catalyzed silicone foam, and any combination thereof.

3. The multilayer composite of claim 1, wherein the flame retardant filler component of the first foam layer comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

4. The multilayer composite of claim 1, wherein the flame retardant filler component of the first foam layer comprises a filler selected from a group consisting of aluminum trihydrate, magnesium dihydroxides, Boehmite, calcium hydroxide, Huntite, gypsum, hydromagnesite, and any combination thereof.

5. The multilayer composite of claim 1, wherein the flame retardant filler component of the first foam layer comprises a filler selected from a group consisting of zinc borate, calcium borate, sodium borate, potassium borate, lithium borate, and any combination thereof.

6. The multilayer composite of claim 1, wherein the flame retardant filler component of the first foam layer comprises a filler selected from a group consisting of platinum-1,3-divinyl-1,1,3,3-tetramethyldisiloxane, hexachloroplatinic acid, and any combination thereof.

7. The multilayer composite of claim 1, wherein the flame retardant filler component of the first foam layer comprises a filler selected from a group consisting of iron oxide, cerium oxide, titanium oxide, zinc oxide, and any combination thereof.

8. The multilayer composite of claim 1, wherein the flame retardant filler of the first foam layer component comprises a filler selected from a group consisting of Huntite, calcium carbonate, and any combination thereof.

9. The multilayer composite of claim 1, wherein the flame retardant filler component of the first foam layer comprises a filler selected from a group consisting of a natural mixture of hydromagnesite and Huntite, synthetic magnesium carbonate hydroxide pentahydrate, and any combination thereof.

10. The multilayer composite of claim 1, wherein the flame retardant filler component of the first foam layer comprises a filler selected from a group consisting of wallastonite, mica, clay, kaolin, talc, vermiculite, and any combination thereof.

11. The multilayer composite of claim 1, wherein the flame retardant filler component of the first foam layer comprises a filler selected from a group consisting of sodium carbonate, potassium carbonate, and any combination thereof.

12. The multilayer composite of claim 1, wherein the insulation filler component of the first foam layer comprises a filler selected from the group consisting of expanded perlite, unexpanded perlite, glass beads, vermiculite, expanded vermiculite, expanded glass, zeolite, aerogel, silica, porous silica, porous alumina, and any combination thereof.

13. A multilayer composite comprising:
a first barrier layer, and
a first foam layer comprising a silicone-based matrix component, a flame retardant filler component and an insulation filler component,
wherein the multilayer composite comprises a thickness of at least about 0.5 mm to and no greater than about 10 mm, and
wherein the multilayer composite comprises a self-ignition time of at least about 1 min when exposed to a hotplate test at 650° C.

14. The multilayer composite of claim 13, wherein the silicone-based matrix component of the first foam layer comprises platinum catalyzed addition cured silicone foam, peroxide cured silicone foam, tin catalyzed silicone foam, and any combination thereof.

15. The multilayer composite of claim 13, wherein the flame retardant filler component of the first foam layer comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites, and any combination thereof.

16. The multilayer composite of claim 13, wherein the flame retardant filler component of the first foam layer comprises a filler selected from a group consisting of aluminum trihydrate, magnesium dihydroxides, Boehmite, calcium hydroxide, Huntite, gypsum, hydromagnesite, and any combination thereof.

17. The multilayer composite of claim 13, wherein the flame retardant filler component of the first foam layer comprises a filler selected from a group consisting of zinc borate, calcium borate, sodium borate, potassium borate, lithium borate, and any combination thereof.

18. The multilayer composite of claim 13, wherein the flame retardant filler component of the first foam layer comprises a filler selected from a group consisting of platinum-1,3-divinyl-1,1,3,3-tetramethyldisiloxane, hexachloroplatinic acid, and any combination thereof.

19. A thermal barrier composite comprising:
a first barrier layer, and
a first foam layer comprising a silicone-based matrix component, a flame retardant filler component and an insulation filler component,
wherein the thermal barrier composite comprises a thickness of at least about 0.5 mm to and no greater than about 10 mm, and
wherein the thermal barrier composite comprises a HBF flammability rating as measured according to ASTM D4986.

20. The thermal barrier composite of claim 19, wherein the flame retardant filler component comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites, and any combination thereof.
